(19) United States
(12) Patent Application Publication
(10) Pub. No.: US 2026/0058991 A1
(43) Pub. Date: Feb. 26, 2026

(54) IN-PATH PER-QUERY SANITIZATION TO DEFEAT DNS TUNNELING

(71) Applicant: Palo Alto Networks, Inc., Santa Clara, CA (US)

(72) Inventors: Daiping Liu, Santa Clara, CA (US); Ruian Duan, Fremont, CA (US); Jun Wang, Sunnyvale, CA (US)

(21) Appl. No.: 19/057,221

(22) Filed: Feb. 19, 2025

Related U.S. Application Data
(60) Provisional application No. 63/686,006, filed on Aug. 22, 2024.

(51) Int. Cl. H04L 9/40

(52) U.S. Cl. CPC H04L 63/1475; H04L 63/1416

(57) ABSTRACT

The present application discloses a method, system, and computer system for detecting DNS tunneling traffic. The method and system perform inline DNS tunneling detection based on a single DNS query. The method includes (i) obtaining a single DNS query, (ii) determining if the single DNS query is associated with DNS tunneling (DNST) using a classifier, (iii) performing active measure in response to determining that the single DNS query is associated with the DNST.

### CROSS REFERENCE TO OTHER APPLICATIONS

This application claims priority to U.S. Provisional Patent Application No. 63/686,006 entitled IN-PATH PER-QUERY SANITIZATION TO DEFEAT DNS TUNNELING filed Aug. 22, 2024 which is incorporated herein by reference for all purposes.

### BACKGROUND OF THE INVENTION

In the ever-evolving landscape of cybersecurity, protecting sensitive data and ensuring the integrity of network communications are of paramount importance. DNS, a fundamental component of the internet infrastructure, translates human-readable domain names into IP addresses that machines use to identify each other on the network. However, this critical service is increasingly being exploited by malicious actors to facilitate DNS tunneling attacks.

DNS tunneling is a method where an attacker encapsulates data within DNS queries and responses, effectively bypassing traditional network security measures such as firewalls and intrusion detection systems. This technique allows the exfiltration of sensitive information or the establishment of covert communication channels within seemingly benign DNS traffic.

Traditional methods of detecting DNS tunneling rely on analyzing the characteristics of DNS traffic, such as the volume of requests, domain name patterns, and entropy of the payload. While these methods can identify some anomalies, they often fall short due to the increasing sophistication of tunneling techniques. Attackers continuously adapt their methods to blend malicious traffic with legitimate DNS queries, making detection increasingly challenging.

The need for more robust detection mechanisms is evident, as current approaches may not adequately address the complexity and stealthiness of modern DNS tunneling attacks. There is a pressing demand for innovative solutions that can effectively identify and mitigate these threats by leveraging advanced analysis techniques on intercepted DNS queries.

### BRIEF DESCRIPTION OF THE DRA WINGS

Various embodiments of the invention are disclosed in the following detailed description and the accompanying drawings.

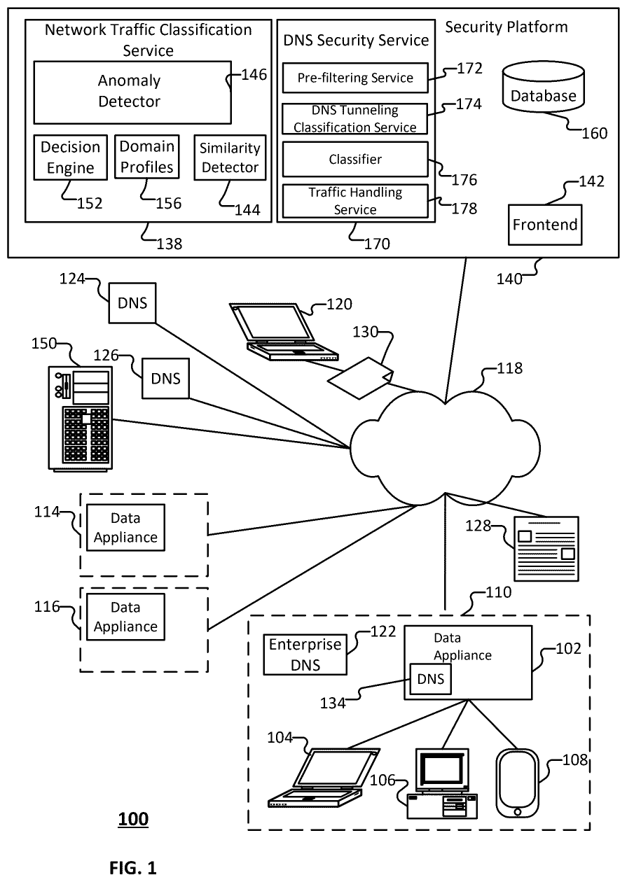

FIG. 1 is a block diagram of an environment for providing a security service to a network according to various embodiments.

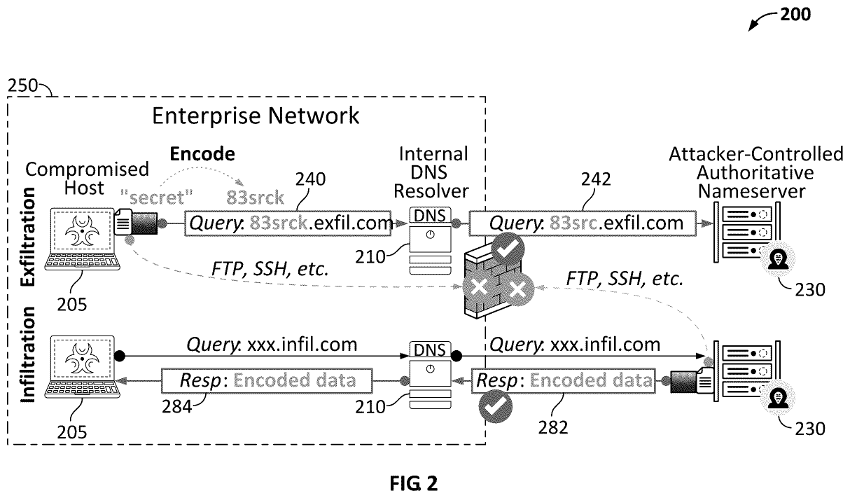

FIG. 2 is an example of a system subject to DNS tunneling exploits.

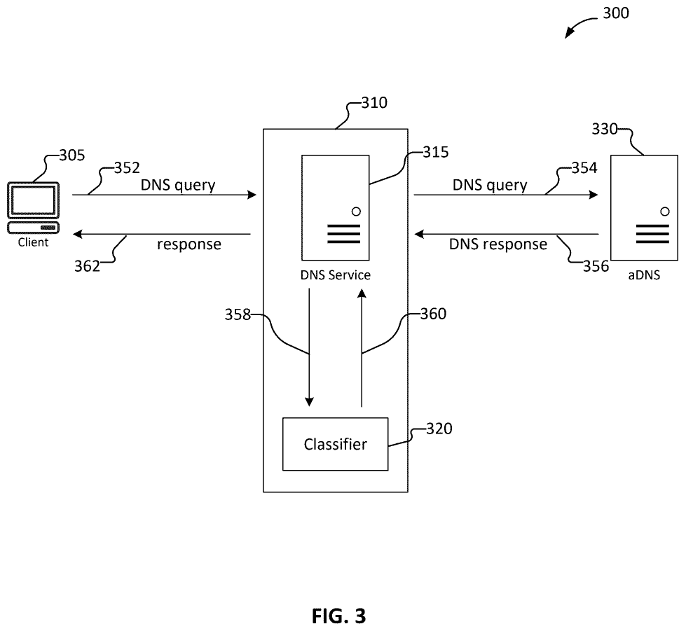

FIG. 3 is a block diagram of a system for providing DNS security services with respect to DNS traffic according to various embodiments.

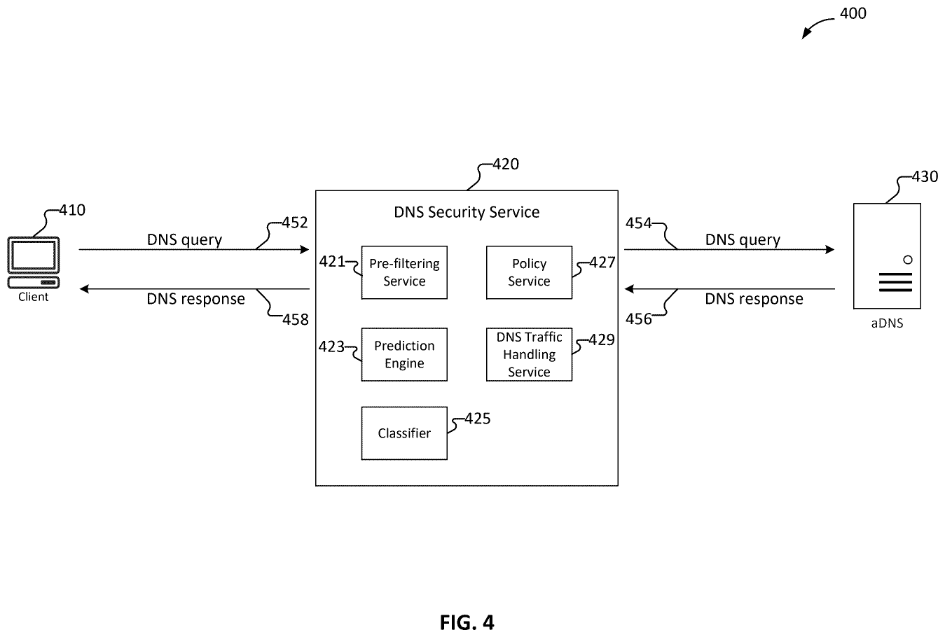

FIG. 4 is a block diagram of a system for providing DNS security services to a network according to various embodiments.

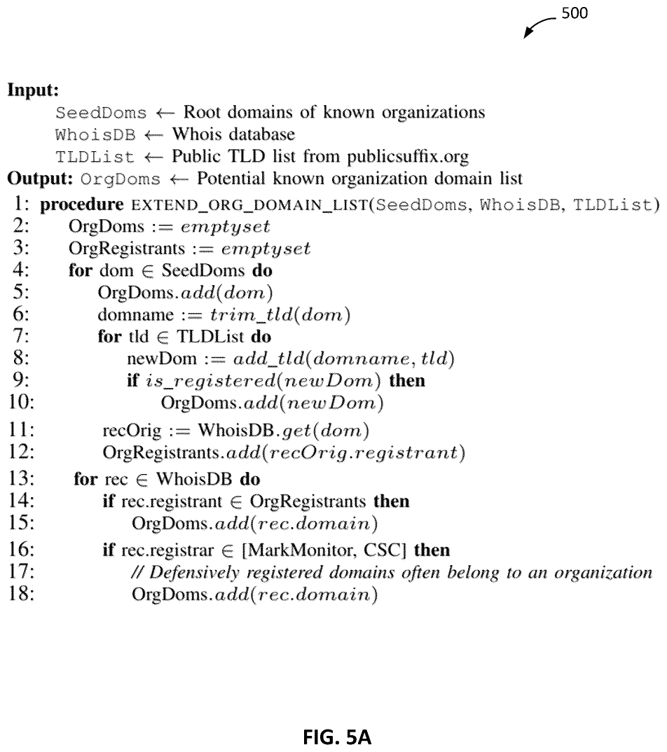

FIG. 5A is an example of a pseudocode for obtaining a known organization domain list according to various embodiments.

FIG. 5B is an example of a pseudocode for computing a meaningful word ratio according to various embodiments.

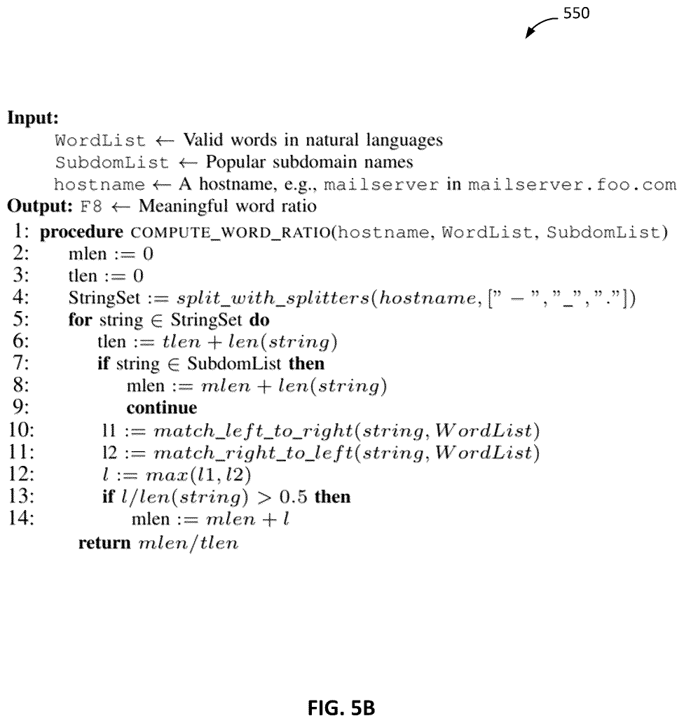

FIG. 6 is a flow diagram of a method for detecting DNS tunneling traffic according to various embodiments.

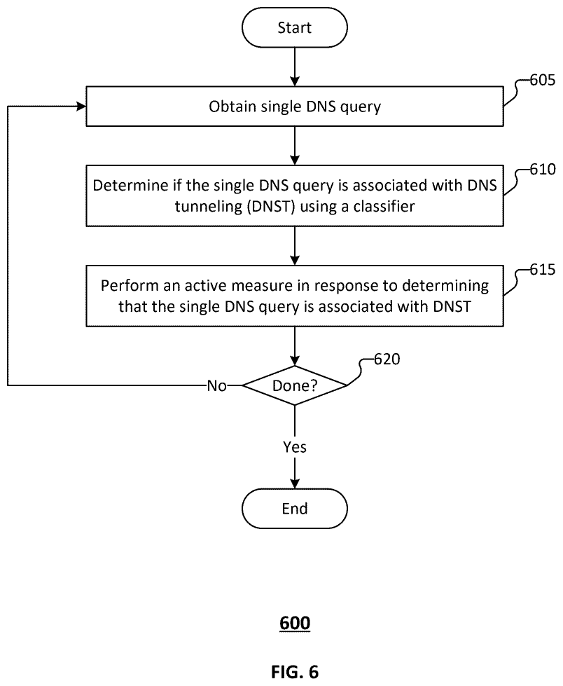

FIG. 7 is a flow diagram of a method for handling DNS traffic according to various embodiments.

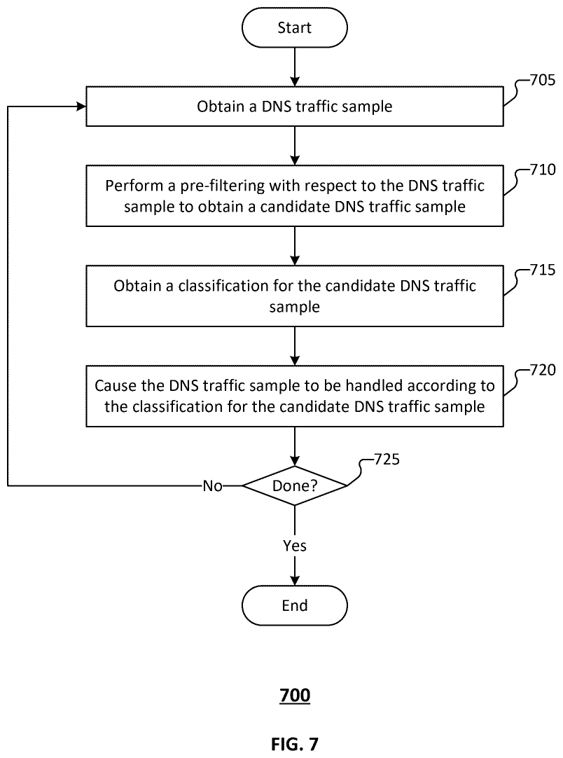

FIG. 8 is a flow diagram of a method for handling DNS traffic according to various embodiments.

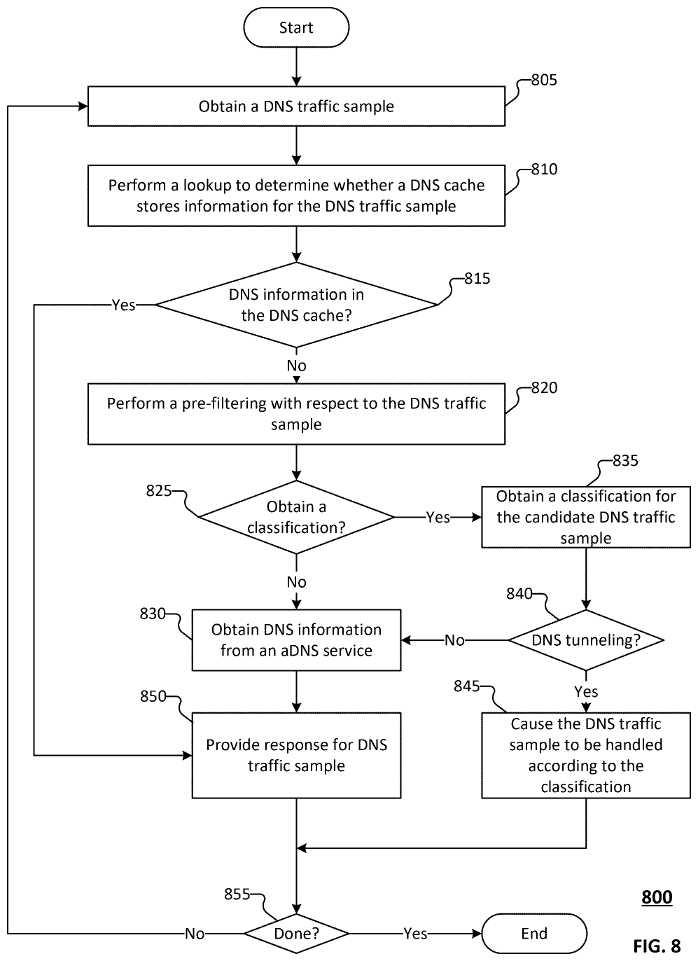

FIG. 9 is a flow diagram of a method for prefiltering DNS traffic according to various embodiments.

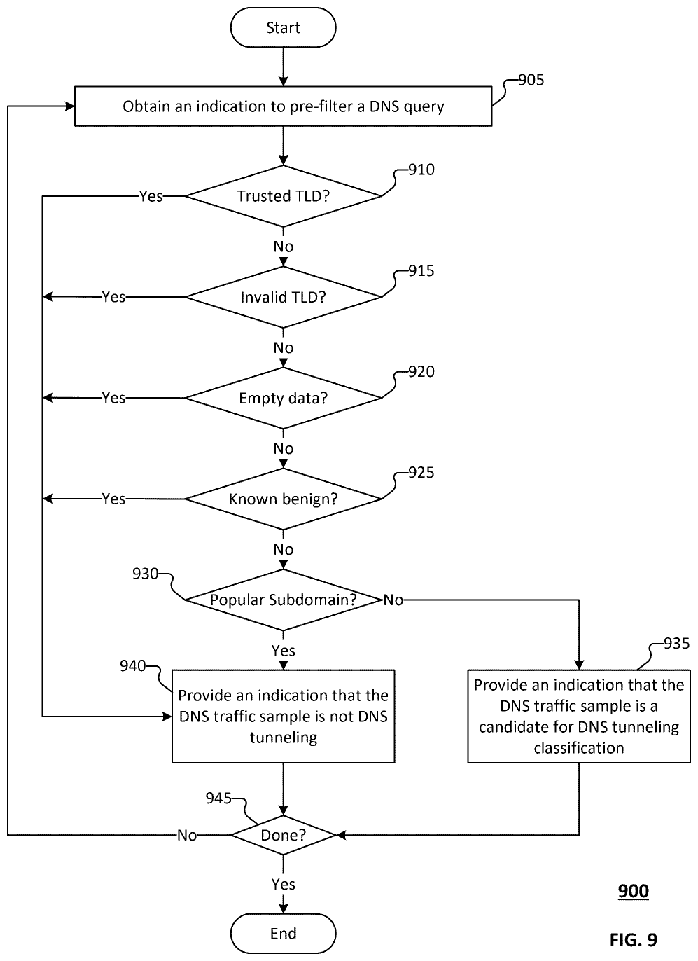

FIG. 10 is a flow diagram of a method for performing a DNS tunnelling classification according to various embodiments.

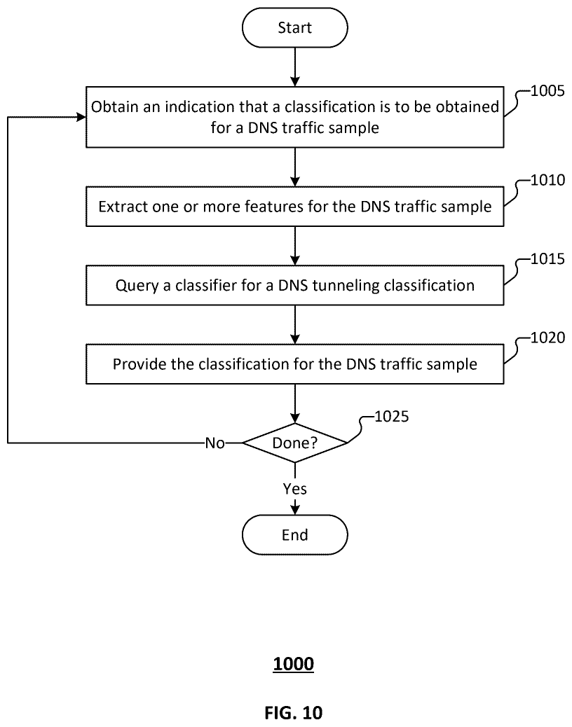

FIG. 11 is a flow diagram of a method for deploying a model for performing DNS tunneling classification according to various embodiments.

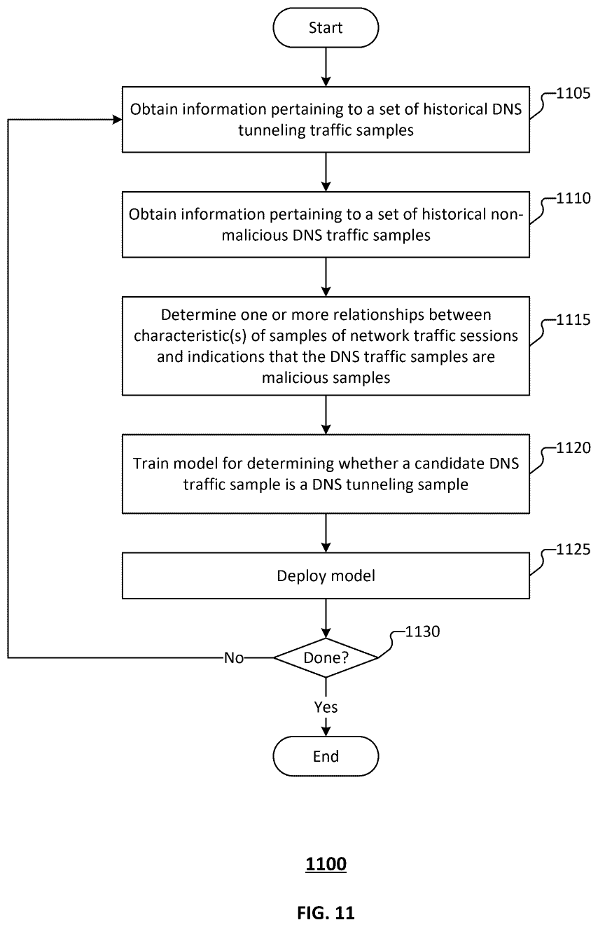

FIG. 12 is a flow diagram of a method for handling DNS traffic based on DNS traffic classifications according to various embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

As used herein, a security entity may be a network node (e.g., a device) that enforces one or more security policies with respect to information such as network traffic, files, etc. As an example, a security entity may be a firewall. As another example, a security entity may be implemented as a router, a switch, a DNS resolver, a computer, a tablet, a laptop, a smartphone, etc. Various other devices may be implemented as a security entity. As another example, a security may be implemented as an application running on a device, such as an anti-malware application.

As used herein, a feature may include a measurable property or characteristic manifested in input data, which may be raw data. As an example, a feature may be a set of one or more relationships manifested in the input data. As another example, a feature may be a set of one or more relationships between text and a product or application, between text and compliance of a product/application with one or more protocols, etc.

As used herein, a model includes a machine learning model and/or a deep learning model. Examples of machine learning processes that can be implemented in connection with training the model include random forest, linear regression, support vector machine, naive Bayes, logistic regression, K-nearest neighbors, decision trees, gradient boosted decision trees, K-means clustering, hierarchical clustering, density-based spatial clustering of applications with noise (DBSCAN) clustering, principal component analysis, etc.

As used herein, a network traffic policy may include a set of rules or guidelines that govern how network traffic is handled, for example, within an organization's network infrastructure. These policies can define the conditions under which certain types of network traffic are allowed, blocked, or prioritized. Network traffic policies are important for ensuring the efficient and secure operation of a network, as they help prevent unauthorized access, protect sensitive data, and optimize the performance of network resources. Policies can be enforced at various levels of the network, including the firewall, routers, switches, and application gateways, and they can be applied based on factors like traffic type, destination, user, time of day, or the identity of the application generating the traffic.

As used herein, a security policy is a set of rules, procedures, and guidelines designed to protect an organization's digital assets, systems, and data from unauthorized access, misuse, or damage. It outlines how sensitive information should be handled, who is allowed to access it, and the measures in place to prevent threats, such as hacking, malware, or data breaches. A security policy can cover various aspects of network security, including access control, encryption, authentication, incident response, and monitoring, with the goal of ensuring the confidentiality, integrity, and availability of the organization's information and resources. By establishing clear protocols, security policies help mitigate risks and ensure that employees, systems, and applications adhere to best practices for safeguarding critical data.

DNS tunneling has long posed a significant security challenge for enterprise networks. In fact, such a surreptitious channel has been widely abused for command and control (C2) and illegitimate virtual private network (VPN). Traditional defenses rely on analyzing statistical patterns extracted from multiple DNS queries over an extended time window. Although such methods have proven useful for post-mortem investigations and threat intelligence, they struggle to prevent data exfiltration in real time, especially during an attacker's earliest queries. For example, related art systems are unable to guarantee zero (or near zero) data leakage and can be evaded when the stolen data is exfiltrated over many root domains. Attackers can thus leak critical information using minimal DNS queries or by dispersing these queries across numerous domains, circumventing volume-based detection techniques. Moreover, many organizations must permit DNS traffic as a matter of operational necessity, and when adversaries exploit this allowance, data loss can occur before defenders have time to recognize and block malicious domains.

According to various embodiments, the techniques disclosed herein address the need for real-time detection of DNS tunneling. For example, the system can implement real-time (or near real-time) in-path prevention of DNS tunneling by introducing a system that inspects and classifies each DNS query individually as it travels toward external authoritative nameservers. Additionally or alternatively, the system can implement real-time detection of DNS tunneling by inspecting/classifying a DNS response/record individually as it travels from an external authoritative nameserver (e.g., to detect infiltration via DNS tunneling). Instead of relying on accumulated statistics across multiple queries, the system classifies the DNS traffic based on distinctive features present in single (e.g., comprised in or exhibited by) DNS requests. The system identifies suspicious characteristics associated with adversary-controlled domains, such as unusual patterns in authoritative nameservers, the likelihood that a domain is managed by a reputable hosting service, and the presence of suspicious characters or encodings in the query string itself. By focusing on these per-query attributes, the system can detect DNS tunneling at the initial attempt, reducing opportunities for data leakage or stealthy command-and-control communication to proceed undetected.

Various embodiments provide techniques by which a system or method is able to achieve in-path per-query DNS tunneling prevention. In some embodiments, the techniques described herein can detect DNS tunneling attacks/campaigns by leveraging an observations that DNS tunneling domains have unique characteristics in their authoritative nameservers, domain usage, and domain name patterns. For example, the system can train a model to perform DNS tunneling detection based on these characteristics, attributes, or patterns. Based on these characteristics, a set of novel features are defined and extracted which are fed to a machine learning model. The efficacy of the implementation of these techniques can be validated by integrating the system into the cloud backend of an enterprise firewall product for a network security service. In empirical testing at the cloud backend (e.g., a cloud security service), the system implementing these techniques successfully detected 358 confirmed tunnels with negligible false positives and negatives.

In some embodiments, the system leverages a combination of efficient prefiltering mechanisms and a machine learning component. The prefiltering stage quickly rules out clearly benign or invalid DNS queries, significantly reducing the computational load for the machine learning classifier (e.g., a model that predicts/generates a DNS tunneling classification). The remaining queries (e.g., the DNS traffic samples that have not been filtered out as deemed benign DNS traffic samples) are then evaluated by a DNS tunneling detection model that learns what typical/benign DNS traffic looks like, and classifying the DNS queries (e.g., by comparing each new query to expected norms). The techniques deployed by the systems and methods herein ensures minimal latency overhead, allowing deployment directly on recursive resolvers, firewalls, or other in-line network devices without degrading the user experience.

Various embodiments provide a method, system, and computer system for detecting DNS tunneling traffic. The method and system perform inline DNS tunneling detection based on a single DNS query. The method includes (i) obtaining a single DNS query, (ii) determining if the single DNS query is associated with DNS tunneling (DNST) using a classifier, (iii) performing active measure in response to determining that the single DNS query is associated with the DNST.

Various embodiments provide a method, system, and computer system for detecting DNS tunneling traffic. The method and system deploy a classifier that is configured to perform inline DNS tunneling detection based on a single DNS query. The method includes (i) obtaining a set of training sample DNS queries, (ii) obtaining DNS traffic information for the set of training sample domains, (iii) performing a machine learning process to generate a DNS traffic classifier, and (iv) deploying the DNS traffic classifier in a system to perform near real-time detection of DNS tunneling traffic.

FIG. 1 is a block diagram of an environment for providing a security service to a network according to various embodiments. In some embodiments, system 100 implements at least part of system 300 of FIG. 3 and/or system 400 of FIG. 4. In some embodiments, system 100 implements at one or more of processes 600-1200 of FIGS. 6-12.

In the example shown, client devices 104-108 are a laptop computer, a desktop computer, and a tablet (respectively) present in an enterprise network 110 (belonging to the “Acme Company”). Data appliance 102 is configured to enforce policies (e.g., a security policy, a network traffic handling policy, etc.) regarding communications between client devices, such as client devices 104 and 106, and nodes outside of enterprise network 110 (e.g., reachable via external network 118). Examples of such policies include policies governing traffic shaping, quality of service, and routing of traffic. Other examples of policies include security policies such as ones requiring the scanning for threats in incoming (and/or outgoing) email attachments, website content, inputs to application portals (e.g., web interfaces), files exchanged through instant messaging programs, and/or other file transfers. Other examples of policies include security policies (or other traffic monitoring policies) that selectively blocking or sinkholing traffic, such as traffic to malicious domains, DNS hijacked domains, stockpiled domains, or squatting domains, or such as traffic for certain applications (e.g., SaaS applications). In some embodiments, data appliance 102 is also configured to enforce policies with respect to traffic that stays within (or from coming into) enterprise network 110.

System 100 comprises a security platform 140 that can provide security services for enterprise networks, for example, by enforcing policies with respect to certain network traffic, such as DNS traffic (e.g., DNS queries, DNS responses, etc.). The system is configured to detect DNS tunneling traffic and determine an appropriate network traffic policy (e.g., a security policy) to be implemented, and handle the corresponding network traffic, for example, by enforcing the network traffic policy. In some embodiments, the system performs DNS tunneling detection based on a single DNS traffic sample (e.g., a single DNS query or a single DNS response/record). For example, the system performs DNS tunneling classification/detection on DNS traffic sample (e.g., DNS query, DNS response) by DNS traffic sample basis.

In some embodiments, the system is configured to obtain DNS traffic samples (e.g., intercept DNS queries) and handle the corresponding DNS traffic based at least in part on performing DNS tunneling detection/classification. The system may pre-filter obtained (e.g., intercepted) DNS traffic samples, for example, to identify DNS traffic samples for which a cache stores corresponding DNS information (e.g., a DNS record) and/or to identify DNS traffic samples for which the cache does not store an entry of DNS information but that the system deems to be benign (e.g., likely benign), etc. In response to performing the pre-filtering, the system obtains a resulting set of candidate DNS traffic samples for which the system obtains (e.g., performs, generates, etc.) a DNS tunneling classification, for example, to predict whether the DNS traffic sample corresponds to a DNS tunneling attack/campaign. In response to detecting DNS tunneling (e.g., in response to obtaining a DNS tunneling classification indicating the DNS traffic sample is DNS tunneling), the system can perform an active measure such as to handle the corresponding network traffic (e.g., the DNS traffic) based on the detection/classification. For example, in the case that the system performs the DNS traffic classification (e.g., the DNS tunneling classification) at a cloud service, such as at security platform 140, based on a request from a security entity (e.g., an inline firewall), the system can provide an indication of the DNS tunneling traffic classification to the security entity or can provide an indication of a policy to be enforced at the security entity. In response to obtaining the indication of the DNS tunneling traffic classification, for example, from security platform 140, a security policy is enforced. For example, an inline security entity applies a security policy with respect to DNS traffic sample in response to obtaining a DNS tunneling classification (e.g., a real-time classification performed at the inline security entity or via a real-time request to a cloud service such as to security platform 140).

Techniques described herein can be used in conjunction with a variety of platforms (e.g., desktops, mobile devices, gaming platforms, embedded systems, etc.) and/or a variety of types of applications (e.g., Android .ask files, iOS applications, Windows PE files, Adobe Acrobat PDF files, Microsoft Windows PE installers, etc.). In the example environment shown in FIG. 1, client devices 104-108 are endpoints, such as a laptop computer, a desktop computer, and a tablet (respectively) present in an enterprise network 110. Client device 120 is a laptop computer present outside of enterprise network 110.

Data appliance 102 can be configured to work in cooperation with remote security platform 140. Security platform 140 can provide a variety of services, including one or more of (a) obtaining DNS traffic samples (e.g., by intercepting DNS traffic or receiving requests from an inline security entity), (b) determining whether the security platform 140 stores (e.g., in a local cache) DNS information (e.g., DNS records) for the DNS traffic sample, (c) handling the DNS traffic sample based on stored DNS information such as if the security platform 140 stores in its cache DNS traffic information for the DNS traffic sample, (d) performing a pre-filtering with respect to the DNS traffic sample, for example, to determine whether the DNS traffic sample is a candidate for DNS tunneling classification or whether the DNS traffic sample is expected to be benign (or likely to be benign), (c) obtaining (e.g., determining) a DNS tunneling classification, (f) querying a classifier for a DNS tunneling classification, (g) evaluating a DNS traffic sample, such as by extracting a set of features from which a model can predict/provide a DNS tunneling classification, (h) handle the DNS traffic according to the DNS tunneling classification, (i) determine a security policy to be enforced with respect to the DNS traffic, (j) provide an indication of the DNS tunneling classification (e.g., to an inline security policy), (k) training a model or other classifier to generate DNS tunnel classifications (e.g., to predict whether DNS traffic samples are DNS tunneling attacks/campaigns), (l) deploying the model or other classifier, etc.

Security platform 140 can provide additional services, including authenticating endpoints, providing secure access to network resources, resolving DNS queries, providing DNS resolving security services, classifying domains (e.g., predicting whether a domain is a malicious domain, etc.), classifying DNS response records (e.g., predicting whether a domain IP pair in a DNS response is a DNS hijacked record, etc.), classifying network traffic, classifying DNS traffic, providing a mapping of signatures to certain domains or DNS records (e.g., a DNS record for which a predicted likelihood that the record is a DNS hijacked record exceeds a predefined likelihood threshold, etc. a mapping of domains or DNS records to domain or DNS record data (e.g., domain certificates, pDNS data, active DNS data, WHOIS data, etc.), performing static and dynamic analysis on malware samples, monitoring new domains and new DNS records (e.g., detecting new domains for which a certificate is issued/generated), assessing maliciousness of domains, determining whether a DNS record associated with a traffic sample is (or is likely to be) a DNS hijacked record, detecting squatting domains, detecting a DNS cache poisoning attack (e.g., an attempt or a DNS cache entry stored based on an effective DNS cache poisoning attack), providing a list of signatures of known exploits (e.g., malicious input strings, malicious files, malicious domains, etc.) to data appliances, such as data appliance 102 as part of a subscription, detecting exploits such as malicious input strings, malicious files, DNS hijacked records or malicious domains (e.g., an on-demand detection, or periodical-based updates to a mapping of domains or DNS records to indications of whether the domains or DNS records are malicious or benign), providing a likelihood that DNS traffic (e.g., a domain or DNS record comprised in the DNS traffic) is malicious or benign, providing/updating a whitelist of input strings, files, or domains deemed to be benign, providing/updating input strings, files, or domains deemed to be malicious, identifying malicious input strings, detecting malicious input strings, detecting malicious files, predicting whether input strings, files, DNS records, or domains are malicious, providing an indication that an input string, file, DNS record, or domain is malicious (or benign), etc.

In some embodiments, network security services, such as policy enforcement services, are implemented at data appliance 102. As an example, data appliance 102 can discover obtain a DNS tunneling classification (e.g., by performing an inline prediction, such as by querying a local model, or by requesting a classification from security platform 140). As another example, data appliance 102 can intercept network traffic (e.g., DNS traffic) and apply appropriate policies based on a determination that the network traffic is associated with a DNS tunneling attack/campaign.

In various embodiments, results of analysis (and additional information pertaining to applications, domains, etc.), such as an analysis or classification performed by security platform 140, are stored in database 160, a local cache (e.g., in a table or other data structure), etc. In various embodiments, security platform 140 comprises one or more dedicated commercially available hardware servers (e.g., having multi-core processor(s), 32G+ of RAM, gigabit network interface adaptor(s), and hard drive(s)) running typical server-class operating systems (e.g., Linux). Security platform 140 can be implemented across a scalable infrastructure comprising multiple such servers, solid state drives, and/or other applicable high-performance hardware. Security platform 140 can comprise several distributed components, including components provided by one or more third parties. For example, portions or all of security platform 140 can be implemented using the Amazon Elastic Compute Cloud (EC2) and/or Amazon Simple Storage Service (S3). Further, as with data appliance 102, whenever security platform 140 is referred to as performing a task, such as storing data or processing data, it is to be understood that a sub-component or multiple sub-components of security platform 140 (whether individually or in cooperation with third party components) may cooperate to perform that task. As one example, security platform 140 can optionally perform static/dynamic analysis in cooperation with one or more virtual machine (VM) servers. An example of a virtual machine server is a physical machine comprising commercially available server-class hardware (e.g., a multi-core processor, 32+ Gigabytes of RAM, and one or more Gigabit network interface adapters) that runs commercially available virtualization software, such as VMware Six, Citrix eServer, or Microsoft Hyper-V. In some embodiments, the virtual machine server is omitted. Further, a virtual machine server may be under the control of the same entity that administers security platform 140 but may also be provided by a third party. As one example, the virtual machine server can rely on EC2, with the remaining portions of security platform 140 provided by dedicated hardware owned by and under the control of the operator of security platform 140.

According to various embodiments, security platform 140 comprises/implements network traffic classification service 138 and/or DNS security service 170. Security platform 140 may include various other services/modules, such as a malicious file detector, a malicious traffic detector, a parked domain detector, an application classifier or other traffic classifier, etc.

Network traffic classification service 138 is used in connection with analyzing network traffic (e.g., websites, domains, sample files, etc. pertaining to the network traffic) and/or automatically detecting malicious network traffic.

DNS security service 170 is used in connection with providing security services for a network, for example, in connection with detecting DNS tunneling attacks/campaigns and securely handling network traffic. DNS security service 170 can be implemented to enforce a security policy for DNS traffic deemed to be (e.g., predicted to be) DNS tunneling, for example, based on a real-time DNS tunneling classification that is performed with respect to a single DNS traffic sample (e.g., a DNS query). In some embodiments, DNS security service 170 performs a DNS tunneling detection and enforcement of policies with respect to DNS traffic classified as DNS tunneling. In response to receiving network traffic (e.g., by receiving a query for a DNS tunneling classification for example from a security entity), DNS security service 170 can determine whether the DNS traffic sample is expected to be (e.g., is likely) a DNS tunneling attack/campaign, and enforcing a network traffic policy (e.g., a security policy) based at least in part on a determination that the DNS traffic sample is expected to be (e.g., is likely) a DNS tunneling attack/campaign.

In some embodiments, DNS security service 170 or a part thereof is implemented at a security entity, such as at data appliance 102. In other embodiments, the detection of application network traffic and appropriately handling the network traffic (e.g., based on determining a DNS tunneling classification or otherwise performing DNS tunneling detection, and an enforcing a security policy applicable to a DNS tunneling detection).

In some embodiments, DNS security service 170 comprises one or more of pre-filtering service 172, DNS tunneling classification service 174, classifier 176, and/or traffic handling service 178.

DNS security service 170 uses pre-filtering service 172 to prefilter DNS traffic samples (e.g., DNS queries). In response to receiving a DNS traffic sample (e.g., a DNS query intercepted by an inline security entity), DNS security service 170 can use pre-filtering service 172 to identify DNS traffic samples that are candidates for DNS tunneling classification. In some embodiments, pre-filtering service 172 queries a local cache or database 160 to determine whether the DNS security service 170 stores DNS information for the DNS traffic sample (e.g., a DNS record for the domain associated with the intercepted DNS query, or an indication of a previously computed DNS traffic classification). In response to determining that the local cache or database 160 stores DNS information for the DNS traffic sample, DNS security service 170 can provide the DNS information (e.g., the DNS record) to the endpoint (e.g., a client system from which a DNS query originated) either directly or via a security entity that had intercepted the DNS traffic sample. If the pre-filtering service 172 determines that the local cache or database 160 does not store DNS information for the DNS traffic sample, pre-filtering service 172 determines whether the DNS traffic sample is a candidate for DNS tunneling classification. In some embodiments, pre-filtering service 172 determines whether the DNS traffic sample is a candidate for DNS tunneling classification based at least in part on one or more of: (a) a determination of whether the domain for the DNS traffic sample corresponds to a trusted top-level domain (TLD), (b) a determination of whether the domain for the DNS traffic sample corresponds to an invalid TLD, (c) a determination of whether the domain for the DNS traffic sample has empty data, (d) a determination of whether the domain for the DNS traffic sample is for a domain that is a known benign domain, and (e) a determination of whether the domain for the DNS traffic sample is for a domain that is a popular subdomain.

In some embodiments, if pre-filtering service 172 deems the DNS traffic sample to not be a candidate for DNS tunneling classification or otherwise determines/deems the DNS traffic sample to be benign in response to a determination of one or more of the following: (a) a determination that the domain for the DNS traffic sample corresponds to a trusted top-level domain (TLD), (b) a determination that the domain for the DNS traffic sample corresponds to an invalid TLD, (c) a determination that the domain for the DNS traffic sample has empty data, (d) a determination that the domain for the DNS traffic sample is for a domain that is a known benign domain, and (e) a determination that the domain for the DNS traffic sample is for a domain that is a popular subdomain. In some embodiments, if pre-filtering service 172 determines that none (a)-(e) above is satisfied, pre-filtering service 172 determines the DNS traffic sample to be a candidate for DNS tunneling classification.

DNS security service 170 uses DNS tunneling classification service 174 to perform a DNS tunneling classification. As an example, DNS tunneling classification service 174 obtains (e.g., determines) the DNS tunneling classification for DNS traffic sample candidates that are identified by pre-filtering service 172. In some embodiments, DNS tunneling classification service 174 queries classifier 176 for a DNS tunneling classification service. For example, DNS tunneling classification service 174 can analyze the DNS traffic sample and extract a set of features for the DNS traffic sample.

DNS security service 170 uses classifier 176 to determine (e.g., generate) a DNS tunneling classification. In some embodiments, classifier 176 predicts whether the DNS traffic sample is associated with a DNS tunneling attack or campaign, or predicts a likelihood that the DNS traffic sample is associated with a DNS tunneling attack or campaign. For example, if classifier determines that the predicted likelihood that the DNS traffic sample is associated with a DNS tunneling attack or campaign exceeds a predefined threshold (e.g., a maliciousness threshold), classifier 176 generates a DNS tunneling classification that indicates that the DNS traffic sample is associated with a DNS tunneling attack or campaign.

In some embodiments, DNS security service 170 uses classifier 176 to train and/or deploy a model that generates predicted DNS tunneling classifications. Classifier 176 can implement a machine learning technique to train the model. In some embodiments, the model is a random forest model. Classifier 176 may implement one or more machine learning models that may be trained according to a machine learning process. Examples of machine learning processes that can be implemented include random forest, linear regression, support vector machine, naive Bayes, logistic regression, K-nearest neighbors (KNN), decision trees, gradient boosted decision trees, K-means clustering, hierarchical clustering, density-based spatial clustering of applications with noise (DBSCAN) clustering, principal component analysis, a neural network (NN), XGBoost, a convolutional neural network (CNN), and LLM etc.

DNS security service 170 uses traffic handling service 178 to handle the DNS traffic based at least in part on the DNS tunneling classification. In some embodiments, traffic handling service 178 determines a security policy to be enforced with respect to the DNS traffic sample, for example, in response to obtaining a DNS tunneling classification that indicates that the particular DNS traffic sample is associated with a DNS tunneling attack or campaign. Traffic handling service 178 can cause the security policy to be enforced with respect to the DNS traffic sample. For example, traffic handling service 178 can enforce the security policy at the security platform 140. As another example, traffic handling service 178 can provide to a security entity (e.g., an inline security entity that had intercepted the DNS traffic sample and queried security platform 140) an indication that the DNS traffic sample is predicted to be DNS tunneling or an indication of the security policy to be implemented, and the security policy can implement the security policy.

Network traffic classification service 138 may comprise an anomaly detector 146 (e.g., configured to detect anomalies in network traffic, file samples obtained by intercepting traffic, DNS traffic, or DNS records, etc.), a decision engine 152 (e.g., configured to predict whether network traffic, intercepted file samples, or whether a DNS record is malicious), domain profiles 156, and/or a similarity detector 144. In some embodiments, network traffic classification service 138 detects malicious network traffic or malware obtained from intercepted network traffic (e.g., by classifying a file sample obtained by a security entity or other network node requesting a maliciousness classification).

Network traffic classification service 138 can determine the classification for network traffic (e.g., a file sample obtained from network traffic, a DNS record, a DNS query, a DNS response, a website content, etc.) based at least in part on querying a classifier(s). The classifier that is queried to provide a classification of the network traffic sample associated with the network activity is a fingerprinting-based classifier, a heuristics-based classifier, another rule-based classifier, and/or a machine-learning based classifier. The classifier may be trained based at least in part on historical samples (e.g., samples of network traffic samples extracted from network traffic). The classifier can be trained based at least in part on a machine learning process.

The classifier(s) may implement one or more machine learning models that may be trained according to a machine learning process. Examples of machine learning processes that can be implemented include random forest, linear regression, support vector machine, naive Bayes, logistic regression, K-nearest neighbors (KNN), decision trees, gradient boosted decision trees, K-means clustering, hierarchical clustering, density-based spatial clustering of applications with noise (DBSCAN) clustering, principal component analysis, a neural network (NN), XGBoost, a convolutional neural network (CNN), and LLM etc.

According to various embodiments, security platform 140 may receive a query from a security entity (e.g., inline firewall, such as a next generation firewall) for a real-time or offline classification of a network traffic sample, such as a file.

According to various embodiments, in response to network traffic classification service 138 classifying the network traffic sample, system 100 handles the corresponding network traffic according to a predefined policy (e.g., a security policy). For example, in response to predicting that the network traffic sample corresponds to malicious network traffic (e.g., that the domain associated with the network traffic is a squatting domain), system 100 can cause the network traffic to be blocked or quarantined, etc. As another example, system 100 can cause traffic to/from a compromised host (e.g., the client system associated with the intercepted network traffic from which the malicious domain was extracted) to be quarantined or sinkholed, etc. (e.g., at least until an administrator actively configures system 100 to proceed with permitting traffic to/from the client system, such as in response to the compromised host being remediated).

According to various embodiments, in response to network traffic classification service 138 classifying the network traffic (e.g., the network traffic sample, or a domain associated with the network traffic sample), system 100 handles the network traffic according to a predefined policy (e.g., a security policy). For example, the system queries a traffic handling policy to determine the manner by which the network traffic (e.g., network activity for a session associated with the network traffic sample) is to be handled. The traffic handling policy may be a predefined policy, such as a security policy, etc. The traffic handling policy may indicate that network traffic associated with certain domains (e.g., domains classified as squatting domains) or having certain characteristics/profiles is to be blocked and network traffic associated with other domains (e.g., domains not deemed to be squatting domains or otherwise malicious) or having other characteristics/profiles is to be permitted to pass through the system (e.g., routed normally). The traffic handling policy may correspond to a repository of a set of policies to be enforced with respect to network traffic. In some embodiments, security platform 140 receives one or more policies, such as from an administrator or third-party service, and provides the one or more policies to various network nodes, such as endpoints, security entities (e.g., inline firewalls), etc.

In response to determining a classification for a newly analyzed network traffic sample (e.g., a newly analyzed domain for a particular network traffic sample, such as a DNS request or DNS response), security platform 140 (e.g., network traffic classification service 138) sends an indication that network activity (e.g., other network traffic samples) associated with the domain are associated with, or otherwise correspond to, the determined classification. Security platform 140 can provide an indication that network traffic matching the network traffic sample predicted to be malicious (e.g., network traffic matching a domain predicted to be a squatting domain) is to be handled as a malicious network traffic. For example, security platform 140 determines (e.g., computes) a signature or identifier for the network traffic/activity (e.g., a hash or other signature, or identifier for the corresponding network session or domain), and sends to a network node (e.g., a security entity, an endpoint such as a client device, etc.) an indication of the classification associated with the signature (e.g., an indication whether the network traffic/activity is a malicious or non-malicious). Security platform 140 may update a mapping of signatures to network traffic sample classifications and provide the updated mapping to the security entity. In some embodiments, security platform 140 further provides to the network node (e.g., security entity, client device, etc.) an indication of a manner by which network traffic/activity matching the network traffic sample or otherwise be associated with the same session as the network traffic sample classified as malicious or matching the signature is to be handled. For example, security platform 140 provides to the security entity a traffic handling policy, a security policy, or an update to a policy.

According to various embodiments, in response to determining the maliciousness classification for a network traffic sample (e.g., obtaining the predicted maliciousness classification, such as from a classifier), network traffic classification service 138 provides an indication of the maliciousness classification, such as to the applicable security entity (e.g., the security entity that provided the network traffic sample or a security entity mediating network traffic for the session associated with the network traffic sample).

Returning to FIG. 1, suppose that a malicious individual (using client device 120) has created malware or malicious sample 130, such as a file, an input string, etc. The malicious individual hopes that a client device, such as client device 104, will execute a copy of malware or other exploit (e.g., malware or malicious sample 130), compromising the client device, and causing the client device to become a bot in a botnet. The compromised client device can then be instructed to perform tasks (e.g., cryptocurrency mining, or participating in denial-of-service attacks) and/or to report information to an external entity (e.g., associated with such tasks, exfiltrate sensitive corporate data, etc.), such as C2 server 150, as well as to receive instructions from C2 server 150, as applicable.

As an illustrative example, the environment shown in FIG. 1 includes three Domain Name System (DNS) servers (122-126). As shown, DNS server 122 is under the control of ACME (for use by computing assets located within enterprise network 110), while DNS server 124 is publicly accessible (and can also be used by computing assets located within enterprise network 110 as well as other devices, such as those located within other networks (e.g., networks 114 and 116)). DNS server 126 is publicly accessible but under the control of the malicious operator of C2 server 150. Enterprise DNS server 122 is configured to resolve enterprise domain names into IP addresses, and is further configured to communicate with one or more external DNS servers (e.g., DNS servers 124 and 126) to resolve domain names as applicable. In some embodiments, DNS security service 170 is implemented at enterprise DNS server 122 rather than, or in addition to, being implemented at security platform 140.

As mentioned above, in order to connect to a legitimate domain (e.g., www.example.com depicted as website 128), a client device, such as client device 104 will need to resolve the domain to a corresponding Internet Protocol (IP) address. One way such resolution can occur is for client device 104 to forward the request to DNS server 122 and/or 124 to resolve the domain. In response to receiving a valid IP address for the requested domain name, client device 104 can connect to website 128 using the IP address. Similarly, in order to connect to malicious C2 server 150, client device 104 will need to resolve the domain, “kj32hkjqfeuo32ylhkjshdflu23.badsite.com,” to a corresponding Internet Protocol (IP) address. In this example, malicious DNS server 126 is authoritative for *.badsite.com and client device 104's request will be forwarded (for example) to DNS server 126 to resolve, ultimately allowing C2 server 150 to receive data from client device 104.

Data appliance 102 is configured to enforce policies regarding communications between client devices, such as client devices 104 and 106, and nodes outside of enterprise network 110 (e.g., reachable via external network 118). Examples of such policies include ones governing traffic shaping, quality of service, and routing of traffic. Other examples of policies include security policies such as ones requiring the scanning for threats in incoming (and/or outgoing) email attachments, website content, information input to a web interface such as a login screen, files exchanged through instant messaging programs, and/or other file transfers, and/or quarantining or deleting files or other exploits identified as being malicious (or likely malicious). In some embodiments, data appliance 102 is also configured to enforce policies with respect to traffic that stays within enterprise network 110. In some embodiments, a security policy includes an indication that network traffic (e.g., all network traffic, a particular type of network traffic, etc.) is to be classified/scanned by a classifier that implements a pre-filter model, such as in connection with detecting malicious or suspicious domains, detecting parked domains, or otherwise determining that certain detected network traffic is to be further analyzed (e.g., using a finer detection model).

In some embodiments, security platform 140 comprises a network traffic classifier that provides to a security entity, such as data appliance 102, an indication of the traffic classification. For example, in response to detecting the C2 traffic, network traffic classifier sends an indication that the domain traffic corresponds to C2 traffic to data appliance 102, and the data appliance 102 may in turn enforce one or more policies (e.g., security policies) based at least in part on the indication. The one or more security policies may include isolating/quarantining the content (e.g., webpage content) for the domain, blocking access to the domain (e.g., blocking traffic for the domain), isolating/deleting the domain access request for the domain, ensuring that the domain is not resolved, alerting or prompting the user of the client device the maliciousness of the domain prior to the user viewing the webpage, blocking traffic to or from a particular node (e.g., a compromised device, such as a device that serves as a beacon in C2 communications), etc. As another example, in response to determining the application for the domain, the network traffic classifier provides to the security entity with an update of a mapping of signatures to applications (e.g., application identifiers).

FIG. 2 is an example of a system subject to DNS tunneling exploits. In the example shown, system 200 comprises an enterprise network 250 comprising one or more endpoints (or to which the one or more endpoints are connected), for example, endpoint 205. Endpoint 205 may be a compromised host that a malicious actor has configured to perform a data exfiltration or a data infiltration via DNS tunneling.

In the case of endpoint 205 implementing a data exfiltration, endpoint 205 can obtain a secret, such as confidential or sensitive stored at endpoint 205 or accessible to the endpoint via enterprise network 250. As shown, endpoint 205 encodes the secret into a DNS query 240. For example, endpoint 205 encodes the “secret” into the alphanumeric string “83srck” which is inserted into the DNS query 240. Endpoint sends the DNS query 240 to an internal DNS resolver 210, which in turn attempts to resolve the DNS. For example, in response to determining that DNS resolver 210 does not store DNS information (e.g., DNS record), DNS resolver 210 forwards the DNS query (e.g., as DNS query 242) to authoritative nameserver 230, which may be controlled by the attacker/malicious actor. The malicious actor can then extract from DNS query 242 the encoded secret and decode the secret to successfully obtain the exfiltrated secret.

In the case of endpoint 205 implementing a data infiltration, authoritative nameserver 230, which may be controlled by the attacker/malicious actor, can provide encoded data to be infiltrated to enterprise network 250 (e.g., to endpoint 205). For example, authoritative nameserver 230 inserts the encoded data to be infiltrated to DNS response 282 and sends DNS response 282 to DNS resolver 210. In turn, DNS resolver 210 uses the DNS response 282 to provide the encoded data to endpoint 205 via DNS response 284.

FIG. 3 is a block diagram of a system for providing DNS security services with respect to DNS traffic according to various embodiments. In some embodiments, system 300 implements one or more of processes 600-1200 of FIGS. 6-12.

In some embodiments, the system can examine the content of the query name to see whether it matches normal linguistic patterns or displays random strings or characters commonly used in encoding schemes. By measuring the length, randomness, or presence of symbols in the subdomain component, the system can detect anomalies that may indicate the exfiltration of hidden data. The system can also assess the overall ratio of meaningful words to unreadable text, recognizing that suspicious queries often lack recognizable language components.

Another valuable source of features involves analyzing the authoritative nameserver records. If the queried domain is served by a newly registered nameserver or one with a history of malicious behavior, this increases the likelihood that the query is part of a tunneling attempt. The system may check if the nameserver appears to host only a single domain or is associated with well-known DNS hosting providers. This difference in hosting patterns can be used to reveal whether a domain is part of a larger, legitimate ecosystem or is more likely controlled by attackers.

In some embodiments, the system evaluates the reputation of the queried domain itself, for example, based on external intelligence feeds, blocklists (e.g., denylists), and historical data on malicious indicators. If a domain shows multiple risk signals, such as registration irregularities or associations with known threat actors, those factors can be combined with the observable traffic patterns to yield a higher anomaly score (e.g., a greater likelihood that the DNS query corresponds to a DNS tunneling attack/campaign). In some embodiments, the system can extract features based on the timing or frequency of requests, particularly if queries targeting the same root domain display sudden bursts or exhibit minimal separation in time. Although many of these characteristics may not be individually sufficient to confirm malicious intent, their combination within a holistic feature set can alert the system to the presence of DNS tunneling even if it occurs during the very first query.

According to various embodiments, the system is typically deployed at a strategic position in the network where it can intercept DNS traffic as it flows between internal clients and external nameserver or where it can be queried by DNS resolvers or inline security entities. As an example, the system can implement the techniques disclosed herein at a recursive resolver, which can ensure that every request (e.g., a DNS query) from a local client (or inline security entity) is analyzed before it leaves the network. In such implementations, the system receives DNS queries as they arrive from endpoints or security entities (e.g., via which the endpoints access a network), examines them for potential DNS tunneling, and then either forwards them to the authoritative nameservers if deemed safe or blocks them outright (or otherwise applies a security policy or implement an active measure) if classified as malicious (e.g., if the DNS traffic sample is deemed to be associated with a DNS tunneling attack/campaign).

In some embodiments, the system is implemented at a security entity, such as a firewall (e.g., a next generation firewall) or a secure web gateway. In such implementations, the system sits along the data path, monitoring all DNS queries and DNS responses that pass through. This configuration can be an effective implementation for enterprises seeking comprehensive traffic inspection without having to reconfigure their existing resolvers, for example, because the security entity can redirect the DNS queries through its own inspection engine before allowing any packets to exit the network perimeter. By monitoring these transactions (e.g., DNS traffic such as DNS queries and/or DNS responses) in real time, the system mitigates or eliminates DNS tunneling, for example, the system ensures that no DNS queries or DNS responses containing suspicious encodings or domain names escapes detection.

Some organizations also implement policies that force/funnel DNS traffic through a designated set of resolvers, preventing endpoints from contacting external DNS servers directly. According to various embodiments, in such a scenario, the system obtains the entire corpus of DNS queries traversing a particular network (e.g., an enterprise network for which a security service is being provided) by being installed on the approved resolvers. Because no DNS query can bypass this controlled resolution path, every attempt to establish a tunnel, whether for data exfiltration or other unauthorized communications, is available for classification. The system's real-time inspection ensures that, regardless of the domain requested or the form of the query, potential threats are detected at the initial transaction.

According to various embodiments, in response to the DNS query being obtained, for example, based on one of the foregoing configurations (e.g., deployed at a security entity, at a DNS resolver, or a cloud security service), the system processes it by applying its feature extraction and classification algorithms. If a response (e.g., a DNS response) returns from external nameservers, the system similarly intercepts that returning traffic, enabling the analysis of infiltration attempts. By operating either at the resolver or via an inline network device (e.g., a security entity), the system can have visibility into both outbound and inbound DNS traffic. This visibility can enable the system to implement a thorough inspection of every DNS message that crosses the network boundary, effectively covering the entire resolution process from query initiation to answer reception.

In some embodiments, the system examines each newly encountered DNS query or DNS response for indicators that it may belong to a tunneling session. According to various embodiments, the system can examine the DNS traffic for such indicators by focusing on the data contained in the domain name, authoritative nameserver records, related metadata associated with the DNS query, etc. Because the classification process is applied (e.g., immediately or in real time) to a single DNS transaction (e.g., a single DNS query), the system can avoid the pitfalls of waiting for aggregated query statistics that related art systems experience. This means, for example, that even the very first attempt to send or receive data through DNS tunneling (e.g., the first DNS query) can be detected (e.g., flagged) and interrupted (e.g., blocked, sinkholed, etc.) before sensitive information leaves (or enters) the network.

In response to obtaining a DNS query, the system inspects features such as the length and structure of the subdomain string, the presence of unexpected or suspicious characters, and the domain's overall reputation. Attackers attempting to embed payloads in the subdomain often rely on encoded strings that exhibit erratic patterns, whereas legitimate domains typically use recognizable words or known brand names. In some embodiments, the system leverages these distinctions to perform a DNS tunneling classification. For example, the system can assign an anomaly score (e.g., predict a likelihood that the DNS query is associated with a DNS tunneling session) in real time. If the score exceeds a configured threshold, the query can be blocked (e.g., immediately or in real time) from reaching the attacker-controlled nameserver.

In some embodiments, the system can detect (e.g., identify) DNS tunneling activity based at least in part on analyzing authoritative nameserver records and reputation. Malicious tunneling domains frequently rely on nameservers owned or controlled by adversaries, often with limited history or apparent association with large-scale DNS hosting services. By assessing these records for indicators that the authoritative nameservers may be under the control of untrusted entities, the system can perform a more comprehensive assessment of the DNS query. In contrast, legitimate domains tend to use managed DNS hosting services run by major (e.g., trusted or reputable) providers or come from nameservers with good reputations and long registration histories.

Additionally, or alternatively, the system can similarly examine the DNS response to determine whether it exhibits characteristics of infiltration. Although most benign DNS responses primarily comprise standard resource records, malicious responses may include payload data disguised as legitimate answers. By applying the same domain-based and reputational analysis, along with checks for suspicious encodings in the returned records, the system can detect anomalies at the first DNS response. This ensures that even if an attacker attempts to push commands, shellcode, or other data back into the network, the response triggers real time scrutiny (e.g., analysis) without relying on statistics from multiple transactions.

By focusing on individual queries or responses rather than long-term traffic behavior, the system according to various embodiments offers quick and reliable protection against data exfiltration and unauthorized communications. The system can operate efficiently at the recursive resolver level or within inline security entities, ensuring minimal latency while adding a vital extra layer of defense. The system performs an active measure in response to detecting a DNS tunneling session (e.g., a DNS tunneling attack or campaign). For example, whenever the system encounters a suspicious DNS query or DNS response, the system can halts the resolution process, preventing the data from passing through and removing the opportunity for attackers to extract information or establish further connectivity.

Returning to the example shown, system 300 comprises a security service 310 (e.g., a DNS security service, such as DNS security service 170 of FIG. 1). Security service 310 can obtain DNS network traffic from client 305 and/or an aDNS service (e.g., aDNS server 330). In some implementations, security service 310 intercepts DNS traffic between client 305 and aDNS server 330. In other implementations, security service 310 receives DNS queries from an inline security entity that has intercepted the DNS traffic from client 305. In some embodiments, security service 310 serves as a DNS resolver that resolves DNS traffic for endpoints connected to a network.

In the example shown, at 352, client 305 sends a DNS query. In response to receiving the DNS query, security service 310 can analyze the DNS query to detect DNS tunneling sessions. In some embodiments, security service 310 comprises DNS service 315 and classifier 320. DNS service 315 may provide DNS services such as resolving DNS queries and detecting malicious DNS traffic. Upon receiving the DNS query, security service can use DNS service 315 to determine whether DNS information (e.g., a DNS record) is stored in a local cache, such as based on previously resolving the domain. If DNS service 315 obtains the DNS record from its local cache, security service 310 can provide the DNS record to client 305. In response to determining that the DNS service 315 does not have a DNS record stored in its local cache for the DNS query, DNS service 315 can perform a pre-filtering to determine whether the DNS query is a candidate for DNS tunneling classification. If the DNS service 315 determines that the DNS query is not a candidate for DNS tunneling classification (e.g., because the DNS service 315 deems the DNS query as benign), DNS service 315 can determine to forward the DNS query to aDNS server 330. Conversely, if the DNS service 315 determines the DNS query is a candidate for DNS tunneling classification, DNS service 315 can cause the DNS tunneling classification to be performed. For example, at 358, DNS service 315 queries a classifier 320 to for a predicted DNS tunneling classification for the DNS query. In response to receiving the request for a DNS tunneling classification, classifier 320 can determine the predicted DNS tunneling classification, such as by querying a machine learning model for an indication of whether the DNS query is associated with a DNS tunneling session or an indication of a likelihood that the DNS query is associated with a DNS tunneling session. At 360, classifier 320 can return the DNS tunneling classification to DNS service 315. If the DNS tunneling classification indicates that the DNS query is expected to be benign, DNS service 315 can forward the DNS query to the aDNS server 330 in connection with resolving the DNA query. Conversely, if the DNS tunneling classification indicates that DNS query is expected to be associated with a DNS tunneling session, DNS service 315 can correspondingly handle the DNS traffic, such as enforcing a security policy with respect to the DNS query (e.g., block a response to the DNS query, etc.).

If the DNS service 315 determines that the DNS query is not a candidate for DNS tunneling classification or if the DNS service 315 receives a DNS tunneling classification that indicates that the DNS query is expected to be benign, at 354, security service 310 (e.g., DNS service 315) forwards the DNS query to aDNS server 330. At 356, aDNS server 330 provides a DNS response for the DNS query, which security service 310 can provide to client 305 at 362.

FIG. 4 is a block diagram of a system for providing DNS security services to a network according to various embodiments. In some embodiments, system 400 implements one or more of processes 600-1200 of FIGS. 6-12.

According to various embodiments, when a DNS query arrives (e.g., is intercepted) that includes an encoded secret intended for a malicious actor-controlled authoritative nameserver, the system examines the subdomain string for patterns that deviate from normal usage. Because most benign domains follow recognizable linguistic conventions, the presence of extensively random or encoded data in the subdomain raises immediate suspicion. This encoded information often reflects attacker efforts to inject payloads or exfiltrate sensitive data without being detected, creating subdomains that appear unintelligible or contain character sets uncharacteristic of typical domain names. By analyzing the structure and composition of the subdomain (e.g., by extracting features for the subdomain and using the features in connection with querying a model), the system can identify unusual patterns that align with known tunneling techniques, such as long Base64-encoded strings or specific delimiters that attackers commonly employ.

In some implementations, as part of the inspection, the system queries internal and/or external data sources (e.g., third-party services) to determine ownership details of the authoritative nameserver that hosts the domain. The system can use the ownership information for the authoritative nameserver in connection with detecting DNS tunneling (e.g., obtaining a DNS tunneling classification). For example, the system can extract one or more features based on the ownership information and use the one or more features in connection with querying a model for the DNS tunneling classification. If the system discovers that the nameserver is newly registered, has a limited traffic history, or shows links to previously detected malicious activity, the risk assessment for this query increases. For example, the model is more likely to predict that the DNS query is associated with a DNS tunneling session. In many cases, domains under malicious actor control exhibit minimal overlap with legitimate hosting services, or they do not appear on lists of recognized or trusted infrastructure maintained by reputable providers. Once combined with the anomaly signals detected in the subdomain itself, these authoritative nameserver indicators can help the system form a more conclusive judgment about the DNS query's intent.

Upon detecting that the DNS query is associated with a DNS tunneling session (e.g., or predicted to be so associated by a classifier such as a machine learning model), the system proceeds to handle the DNS query based on the classification. For example, the system can cause a security policy to be enforced (e.g., either directly enforce or cause a security entity via which the endpoint accesses the network to enforce). As an example, the system can cause the DNS query to be blocked or quarantined. The system can perform this active measure in real time, such as to immediately halt the DNS resolution process before any data can be effectively transferred to the attacker's infrastructure. The system may further categorize the root domain associated with this nameserver as high risk, allowing it to swiftly respond to any subsequent queries attempting to leverage the same malicious infrastructure. In doing so, the system can ensures that even stealthy, first-time exfiltration attempts are caught at the earliest opportunity, preventing the attacker from successfully leaking or retrieving sensitive information.

In some embodiments, the system determines whether the DNS traffic corresponds to a DNS tunneling session (e.g., the system obtains a DNS tunneling classification for a DNS query) based on querying a classifier, such as a machine learning model. The system can perform feature extraction with respect to the particular DNS traffic sample (e.g., DNS query) in connection with querying a machine learning model for a DNS tunneling classification. Feature extraction may begin by analyzing the domain name requested in the DNS query. The system identifies the root domain and parses any subdomains, inspecting them for unusual length, random-looking strings, or characters that deviate from standard naming conventions. The machine learning model can be trained to assign a score indicating how likely the query is to represent normal human-readable content as opposed to suspiciously encoded data based at least in part on a determination that the domain name segments contain recognizable words or popular subdomain patterns, the system can. The system may also check for known or trusted top-level domains and discard those queries from deeper analysis if they appear obviously legitimate.

The system may use various other associated information to determine the DNS tunneling classification. For example, the system can extract one or more features based on this other information that the system gathers. In some implementations, the system gathers information about the authoritative nameserver that serves the domain in the DNS query. To do this, it may reference/query external databases containing passive DNS records or use live queries to discover the nameserver's domain name, IP address, hosting provider, and historical usage. If the nameserver is found to host a large number of unrelated domains, this often signifies a major hosting provider, which is more likely to be benign. Conversely, if the nameserver appears to be dedicated or newly created, the domains traffic may be deemed suspicious. For example, a machine learning model trained for performing DNS tunneling classification may use this information indicating the domain's traffic could be suspicious in connection with determining the result/score for the DNS tunneling classification (e.g., a score of the likelihood that the DNS query corresponds to a DNS tunneling session). The system can also evaluates the reputation of the nameserver's domain through sources such as blocklists or historical security event logs, noting whether it has been reported in connection with malicious activity, and the system use this information in connection with obtaining the DNS tunneling classification, for example, by extracting features based on this information.

The system may obtain one or more features based at least in part on cross-referencing known legitimate and malicious domain lists. As an example, if the domain appears on a predefined (e.g., a curated) whitelist of widely used domains, such as those belonging to major technology companies or widely trusted content providers, the system (e.g., the machine learning model) may consider the DNS query low risk (e.g., less likely to be associated with a DNS tunneling session). Conversely, if the domain is comprised in blacklists or is associated with suspicious patterns in the global DNS ecosystem, the system (e.g., the machine learning model) may consider the DNS more suspicious (e.g., more likely to be associated with a DNS tunneling session). The system can also obtain WHOIS records (e.g., based on querying a third party service) for domain registration data for the domain associated with the DNS query. The system can analyze the DNS records, for example, to determine whether the domain was recently created (e.g., created within a threshold time period, such as the last thirty days) and/or to determine whether the domain is registered with false or incomplete information. These attributes, particularly in combination with the domain's reputation and usage history, provide a strong indication of whether an attacker is using a makeshift infrastructure to support DNS tunneling.

In some embodiments, the system extracts one or more features based on metrics such as the presence of suspicious characters or unusual encoding schemes in the query name. Tunneling software frequently encodes data in Base64 or other formats, leading to subdomains with peculiar lengths or character distributions. If certain patterns of punctuation or symbols are discovered, particularly punctuation or symbols that rarely appear in legitimate queries, the system (e.g., the machine learning model) can deem the DNS query to be more likely malicious (e.g., DNS tunneling traffic).

In some embodiments, the system consolidates these various signals into a unified feature vector, the system creates a concise representation of each DNS query's risk profile. This feature vector is then fed into a classification algorithm (e.g., to a machine learning model), which evaluates the likelihood that the DNS query belongs to a tunneling session based on how its features align with previously identified malicious or benign behaviors.

According to various embodiments, the system obtains information pertaining the DNS query and information associated with the domain and extracts one or more features. The one or more features may be based at least in part on one or more of (a) aDNS characteristics), (b) a determination that the domain is a potential legitimate organization domain, (c) a determination of whether the domain is likely used to host benign services, (d) a length of transferred data, (e) a ratio of meaningful words extracted from the domain in the DNS query, and (f) special characters in the domain in the DNS query. These feature vectors are further described in Table 1 below.

TABLE 1

| Feature Type | Description |
|---|---|
| aDNS characteristics | The aDNS of a tunneling domain often has unique |
| | characteristics |
| Potential legitimate organization domain | Is the root domain potentially owned by a valid |
| | organization? |
| Likely hosting benign services | Is this domain visited by benign software |
| Length of transferred data | Number of bytes that are potentially exfiltrated |
| Ratio of meaningful words | Ratio of meaningful words in the subdomain |
| Suspicious characters | Does the domain name comprise characters not in |
| | the set {a . . . z, -, _, 0 . . . 9} |

According to various embodiments, the system extracts one or more features pertaining to aDNS characteristics in connection with obtaining a DNS tunneling classification. Users typically prefer hosting their domains on managed DNS services for easier management, better performance and higher reliability. Users store their authoritative DNS records on the aDNS servers managed by a service provider. By contrast, malicious actors generally set up their own aDNS for tunneling. Many managed DNS services (e.g., the one provided by GoDaddy at godaddy.com) do not export raw DNS logs to users, and as a result, malicious actors are not able to obtain the exfiltrated data and thus they could not leverage this kind of managed services. For those managed DNS services allowing users to access raw DNS logs, they still lack flexibility for malicious actors to dynamically customize DNS responses. In real-world DNS tunneling campaigns, adversaries commonly need to dynamically generate responses for the sake of remote control and reliable communications. Empirical studies show that all publicly revealed advanced persistent threat (APT) campaigns and VPN services over DNS (e.g., Astrill and HA-Tunnel) set up their own dedicated aDNS servers. Based on these insights, the system implements at least four features to model the aDNS characteristics of tunneling domains.

The first feature pertaining to an aDNS characteristic is set to 1 if any aDNS server of associated domains (e.g., the set of upper-level domains of the domain in the DNS query) is likely under the control of attackers. The system may deem the following two types of aDNS servers to be potentially/likely controllable by attackers: (i) an aDNS server has the same root domain as the domain in the DNS query, and (ii) an aDNS server is hosted on a dynamic DNS service. Otherwise, the system sets this first feature to 0.

The second feature pertaining to an aDNS characteristic is built upon the intuition that the more domains an aDNS server hosts, the more likely it belongs to a managed DNS hosting service. Thus, this feature is configured in attempt to model the popularity of aDNS. Specifically, for an aDNS server in the set of all aDNS servers for the set of upper-level domains, the system first obtains all domains that are delegated to it and then counts the number of unique root domains. The system further counts the number of distinct root domains that are resolved to the IP addresses of the aDNS server. In case of multiple IP addresses of aDNS servers, we choose the maximum. In some embodiments, the system determines the popularity for an aDNS server. For example, if the popularity for the aDNS exceeds a predefined popularity threshold, the system sets this feature to 1, and if the popularity for the aDNS does not exceed the predefined popularity threshold, the system sets the feature to 0. As an example, the system sets the feature set to 1 in response to determining that all aDNS servers for the set of upper-level domains of the domain the DNS query are likely managed services.

The third feature pertaining to an aDNS characteristic is configured to measure/represent the reputation of aDNS domains. The system deems domains with high traffic volume (e.g., a traffic volume exceeding a predefined traffic volume threshold) or long history (e.g., a history that exceeds a predefined length of time) to have a high reputation. In some embodiments, the set of high reputation domains combines i) Tranco top 1 million along with the root domains of their aDNS, and ii) domains whose ages are longer than 5 years. The system can filter out known malicious domains (e.g., before setting the feature value).

The fourth feature pertaining to an aDNS characteristic is based at least in part on a number of aDNS servers for the domain and/or a number of IP addresses to which aDNS servers for the domain are resolved. For example, a tunneling domain usually either has just one aDNS server or all aDNS servers for the domain are resolved to the same IP. Malicious attackers may adopt this design for two main reasons: (a) attackers want to minimize the footprint and cost in their attack infrastructures, and (b) using a single aDNS server can simplify the implementation and improve the maintainability of tunneling tools (e.g., because sophisticated tunneling tools often need to establish stateful communication channels for control purposes). The resolution behavior can be unpredictable in the presence of multiple aDNS servers and an intermediate resolver might randomly pick one aDNS server to forward a DNS query. Therefore, tunneling tools using multiple aDNS servers on different IPs must synchronize each aDNS server in real-time to maintain stateful communication. In contrast, non-tunneling domains typically rely on stateless DNS resolution, using multiple aDNS servers on different IPs to enhance reliability and reduce resolution latency. Even for benign tunneling domains, there are often multiple aDNS IPs. The system sets this feature to if any of the upper-level domains for the domain in the DNS query has only one aDNS IP. Otherwise, the system sets this feature to 0.

According to various embodiments, the system extracts one or more features pertaining to a determination of whether a domain is a potential legitimate organization domain in connection with obtaining a DNS tunneling classification. Intuitively, if a domain is owned by a legitimate organization, it is unlikely that the domain will be used for malicious tunneling. Unfortunately, compiling a complete mapping between legitimate organizations and all domains owned by them can be challenging. In some embodiments, the system obtains (e.g., collects) known organizations and their main domains. Then, the system searches for the domains potentially owned by these known organizations using the algorithm shown in pseudocode 500 of FIG. 5A. By using this algorithm, the system attempts to extend a seed domain by enumerating all TLDs to replace its original TLD and checking the domain owner using registrant name and emails in WHOIS database. If there is a match with the seed domain's WHOIS information, the enumerated domain is considered owned by the same organization and thus added into the generated list. The system can exclude anonymous and invalid registration information. The system can deem domains with registrars MarkMonitor and CSC as organization-owned because they are commonly defensively registered by a legitimate organization. The system sets the value for this feature to 1 if the root domain is in the generated domain list. Otherwise, the system sets the value for this feature 0.

According to various embodiments, the system extracts one or more features pertaining to a determination of whether a domain is associated with a likely hosting benign services. In order to avoid false positives caused by legitimate applications and services that exhibit tunneling-like behaviors the system collect as much benign software as possible and monitor their runtime behaviors in order to train the machine learning model based on this information. Domains visited by these benign software are also likely to be benign. Similarly, if a web application provides legitimate services and contents, the hosting domains are unlikely to be used for malicious tunneling activities. In practice, collecting a full list of benign applications or determine precisely whether an application is benign is extremely difficult. To address this, the system can rely on two sources to collect the domains likely hosting benign services. First, the system can obtain information from third-party services, for example public and/or propriety commercial services, such as VirusTotal and ANY.RUN. These services can provide dynamic code sample analysis and identify the malicious ones. Another benefit to using these third-party services is they generally have a very large repository of application samples. Second, the system can collect information from security services that determine a domain's category based on the hosted content. For example, google.com is categorized as search engines by three vendors on VirusTotal. According to various embodiments, for this feature, the system considers a domain as likely hosting benign services if any domain in the upper-level domains for this domain is visited by a benign application or categorized as a legitimate service. An application is considered as benign if it is not classified as malicious and it has a valid certificate with a potentially legitimate organization in the certificate subject. The system sets the value of this feature to 1 in response to a determination that the domain is likely hosting benign services. Otherwise, the system sets this feature to 0.

According to various embodiments, the system extracts one or more features pertaining to length of transferred data. Due to the data exfiltration nature of DNS tunneling, a the system can implement a feature that is configured to measure how much data is transferred. In some embodiments, the system uses the hostname as a proxy for the exfiltrated data. For example, the system assumes the hostname part of a subdomain contains exfiltrated data. The feature can be configured as the number of bytes of the hostname part. As an illustrative example, the dot “.” in the hostname part can be omitted. For instance, given host.name.foo.com, the concatenation of host and name is considered as the transferred data.

According to various embodiments, the system extracts one or more features pertaining to a ratio of meaningful words in the hostname. Data exfiltrated in DNS tunneling is commonly encoded and thus the hostname part of a tunneling FQDN rarely contains meaningful words. However, legitimate subdomains prefer meaningful words (e.g., webmail and forum). The system can use this observation to use the ratio of meaningful words as a feature used to predict whether a DNS query is for a DNS tunneling session. The system can compute the ratio of meaningful words in the hostname part of a FQDN. For example, the ratio of meaningful words can be computed based on a total length of meaningful words in the hostname in relation to a total length of the hostname. In some embodiments, the system computes the ratio of meaningful words in the hostname based at least in part on the algorithm shown in pseudocode 550 shown in FIG. 5B. The system can use a set of lists in connection with identifying meaningful words so the system can compute the ratio of meaningful words in the hostname. For example, the system can use a first list comprising valid words in natural languages (e.g., denoted as WordList in pseudocode 550), and a second list that comprises popular subdomain names (e.g., denoted as SubdomList in pseudocode 550). In some embodiments, for inclusion into one of these lists, the words must satisfy three criteria: (a) the word has at least four characters; (b) the word must contain at least one character in {a-z}, and (c) the word only contains characters in {a-z,0-9}. The system can split a hostname into separate strings using three splitters {-,_,.}. If a string exactly matches a word in SubdomList, the system can deem the string as a meaningful word. Otherwise, the system can attempt to match the string against WordList maintained in a Trie. In some embodiments, the system counts a word in the final result of meaningful words if more than half of a string is matched in the WordList Trie. As an example, the system can exclude the accidental partial matches for tunneling FQDNs. This heuristic can be implemented to avoid false negatives for tunneling FQDNs with relatively short hostnames.

According to various embodiments, the system extracts one or more features pertaining to suspicious characters in the DNS query, particularly the queried domain. DNS tunneling tools usually implement encoding schemes that result in suspicious characters in the queried domains. For example, BASE64 is a popular encoding scheme among DNS tunneling tools. As a result, the domains in these tunneling queries can contain characters+ and = which are rarely seen in non-tunneling traffic. The system can use this heuristic to generate a feature that is set to 1 if a domain name contains characters not in {a-z,-,_,*,0-9}, and is otherwise set to 0.

According to various embodiments, after determining whether a DNS query belongs to a tunneling session, the system stores its classification verdict (e.g., the DNS tunneling classification) in a local cache to expedite the handling of future traffic for the same domain. This caching mechanism enables the system to avoid having to re-evaluate the same domain repeatedly, reducing both the computational load and the latency that network users experience. By referring to the cached verdict, the system can quickly decide whether to block or allow subsequent DNS queries without subjecting them to the entire classification process again.

The system can assign different cache lifetimes based on the category of the domain. For example, the system may store the verdict of a confirmed tunneling domain for a relatively long period, preventing any subdomains of that malicious root domain from being inadvertently accessed. On the other hand, if the domain has been classified as benign, the system might store that verdict for a shorter duration so that it can accommodate newly discovered behaviors if the domain's reputation changes. This balance of cache durations can be used to ensure that the system remains both efficient and adaptive, reflecting the constantly evolving nature of online threats.

When the system encounters future DNS queries for a cached domain, the system can perform a lookup for the stored classification result, if any, to quickly determine the correct enforcement action. If the domain is marked in the cache as malicious, the system enforces the applicable security policy (e.g., the same block or sinkhole policy) without re-running advanced checks. Conversely, if the domain is marked in the cache as benign, the system allows the resolution to continue unimpeded. This approach is especially valuable for high-volume traffic scenarios in which multiple subdomains or repeated queries arise for a single root domain. By caching the classification verdict, the system can save a considerable amount of time and processing resources across potentially thousands of queries.

Returning the example shown, system 400 comprises a DNS security service 410 (e.g., a DNS security service, such as DNS security service 170 of FIG. 1). DNS security service 410 can obtain DNS network traffic from client 405 and/or an aDNS service (e.g., aDNS server 430). In some implementations, DNS security service 410 intercepts DNS traffic between client 405 and aDNS server 430. In other implementations, DNS security service 410 receives DNS queries from an inline security entity that has intercepted the DNS traffic from client 405. In some embodiments, DNS security service 410 serves as a DNS resolver that resolves DNS traffic for endpoints connected to a network.

DNS security service 410 comprises pre-filtering service 421, prediction engine 423, classifier 425, policy service 427, and/or DNS traffic handling service 429.

DNS security service 410 uses pre-filtering service 421 to prefilter DNS traffic samples (e.g., DNS queries). In response to receiving a DNS traffic sample (e.g., a DNS query intercepted by an inline security entity), DNS security service 410 can use pre-filtering service 421 to identify DNS traffic samples that are candidates for DNS tunneling classification. In some embodiments, pre-filtering service 421 queries a local cache to determine whether the DNS security service 410 stores DNS information for the DNS traffic sample (e.g., a DNS record for the domain associated with the intercepted DNS query, or an indication of a previously computed DNS traffic classification). In response to determining that the local cache or database 160 stores DNS information for the DNS traffic sample, DNS security service 410 can provide the DNS information (e.g., the DNS record) to the endpoint (e.g., a client system from which a DNS query originated) either directly or via a security entity that had intercepted the DNS traffic sample. If the pre-filtering service 421 determines that the local cache does not store DNS information for the DNS traffic sample, pre-filtering service 421 determines whether the DNS traffic sample is a candidate for DNS tunneling classification.

DNS security service 410 uses prediction engine 423 to obtain a prediction of whether the DNS traffic sample (e.g., the DNS query) corresponds to a DNS tunneling session (e.g., a DNS tunneling attack or campaign). Prediction engine 423 can extract a set of features based on the DNS query (e.g., based on the domain for the DNS query) and query classifier 425 for a DNS tunneling classification prediction based at least in part on the set of features.

DNS security service 410 can use policy service 427 to enforce one or more security policies with respect to the DNS traffic based at least in part on the DNS tunneling classification. For example, policy service 427 determines a predefined policy to be applied, and DNS security service 410 uses DNS traffic handling service 429 to handle (or cause a security entity that intercepted the DNS traffic and queried DNS security service 410 to handle) the DNS traffic based on the applicable security policy.

If the DNS security service 410 determines that the DNS query is not a candidate for DNS tunneling classification or if the DNS security service 410 obtains a DNS tunneling classification that indicates that the DNS query is expected to be benign, at 454, DNS security service 410 (e.g., DNS traffic handling service 429) forwards the DNS query to aDNS server 430. At 456, aDNS server 430 provides a DNS response for the DNS query, which DNS security service 410 can provide to client 405 at 458.

FIG. 5A is an example of a pseudocode for obtaining a known organization domain list according to various embodiments. In some embodiments, the system can implement the algorithm provided in pseudocode 500 to identify/search for domains associated with (e.g., owned or controlled by) an organization.

FIG. 5B is an example of a pseudocode for computing a meaningful word ratio according to various embodiments. In some embodiments, the system can implement the algorithm provided in pseudocode 550 to determine a meaningful word ratio, which can be used in connection with determining a feature value for a feature used by a model to generate a predicted DNS tunneling classification.

FIG. 6 is a flow diagram of a method for detecting DNS tunneling traffic according to various embodiments. According to various embodiments, process 600 is implemented at least in part by one or more of system 100 of FIG. 1, system 300 of FIG. 3, and/or system 400 of FIG. 4.

In some implementations, process 600 may be implemented by one or more servers, such as in connection with providing a service to a network (e.g., a security entity and/or a network endpoint such as a client device). In some implementations, process 600 may be implemented by a security entity (e.g., a firewall) such as in connection with enforcing a security policy with respect to files communicated across a network or in/out of the network. In some implementations, process 600 may be implemented by a client device such as a laptop, a smartphone, a personal computer, etc., such as in connection with communicating DNS traffic across a network.

At 605, the system obtains a single DNS query. At 610, the system determines if the single DNS query is associated with DNS tunneling (DNST) using a classifier. At 615, the system performs an active measure in response to determining that the single DNS query is associated with DNST. At 620, the system determines whether process 600 is complete. In some embodiments, process 600 is determined to be complete in response to a determination that no further samples (e.g., DNS queries) are to be analyzed (e.g., no further predictions for traffic are needed), no further DNS traffic is to be classified, no further network traffic is received/intercepted, an administrator indicates that process 600 is to be paused or stopped, etc. In response to a determination that process 600 is complete, process 600 ends. In response to a determination that process 600 is not complete, process 600 returns to 605.

FIG. 7 is a flow diagram of a method for handling DNS traffic according to various embodiments. According to various embodiments, process 700 is implemented at least in part by one or more of system 100 of FIG. 1, system 300 of FIG. 3, and/or system 400 of FIG. 4.

In some implementations, process 700 may be implemented by one or more servers, such as in connection with providing a service to a network (e.g., a security entity and/or a network endpoint such as a client device). In some implementations, process 700 may be implemented by a security entity (e.g., a firewall) such as in connection with enforcing a security policy with respect to files communicated across a network or in/out of the network. In some implementations, process 700 may be implemented by a client device such as a laptop, a smartphone, a personal computer, etc., such as in connection with communicating DNS traffic across a network.

According to various embodiments, when the system reaches a classification result for a DNS query or response, the system takes action (e.g., implements an active measure) in real time to enforce the security policy determined by that result. As an example, if a DNS query or response is identified as benign, the system simply allows the DNS resolution process to continue uninterrupted. In this case, the DNS resolver forwards the DNS query to the intended authoritative server or relays the server's response back to the requesting client/endpoint. By not interfering with legitimate traffic, the system maintains normal network operations without adding unnecessary overhead or user disruption.

In contrast, when the classification process reveals that a given DNS query or response is likely part of a tunneling activity (e.g., the predicted DNS tunneling classification indicates that the DNS traffic is likely a DNS tunneling session), the system implements an active measure (e.g., according to a predefined security policy), such as intercepting and blocking or performing another active measure with respect to the DNS traffic before any data can be leaked from, or malicious commands introduced into, the network. Depending on the configuration of the system, this interception can be enforced directly within a modified DNS resolver, by a security entity, or through integrated functionality in a security gateway. In each configuration, the system's classification logic can trigger a protective action, which may include dropping the DNS packet, redirecting it to a sinkhole domain for further analysis, or logging the event in a centralized platform for incident investigation. The system can perform the DNS traffic classification within milliseconds, which enables the system to ensure that even a first attempt at DNS tunneling will not be successful.

In some instances, administrators may configure the system to apply different handling rules based on the severity or confidence of the detection. As an example, for queries with borderline classification scores (e.g., greater than a first likelihood threshold corresponding to a low likelihood classification and less than a second likelihood threshold corresponding to a high likelihood classification), the system can quarantine or sandbox the domain, potentially allowing further checks or gathering additional context before definitively blocking it. Conversely, if a query definitively scores as malicious (e.g., the DNS traffic classification has a score that exceeds a likelihood threshold corresponding to a likely or very likely DNS tunneling activity), the system can promptly (e.g., in real time or instantly) terminate the transaction. This dynamic approach enables the system to accommodate varying organizational needs, letting security teams calibrate their blocking thresholds to balance the risks of false positives against the imperative to prevent data loss.

The system can additionally cache its classification decisions. For example, once a root domain or nameserver is flagged as malicious (e.g., likely to be associated with DNS tunneling activity), subsequent queries related to that domain can be automatically denied for a predetermined time period. This can enable the system to prevent repetitive processing of the same suspicious traffic and enhances the system's overall throughput. Similarly, if a domain is deemed benign, the system may cache that verdict for a shorter period, ensuring a smooth user experience. By combining real time active measures (e.g., blocking actions) with intelligent caching, the system can prevent or reduce repeated analysis of known risks, thereby optimizing resource usage, and ensuring a robust protective presence throughout DNS operations.

Returning to the example shown, at 705, the system obtains a DNS traffic sample. At 710, the system performs a prefiltering with respect to the DNS traffic sample to obtain a candidate DNS traffic sample. At 715, the system obtains a classification for the candidate DNS traffic sample. At 720, the system causes the DNS traffic sample to be handled according to the classification for the candidate DNS traffic sample. At 725, the system determines whether process 700 is complete. In some embodiments, process 700 is determined to be complete in response to a determination that no further samples (e.g., DNS queries) are to be analyzed (e.g., no further predictions for traffic are needed), no further DNS traffic is to be classified, no further network traffic is received/intercepted, an administrator indicates that process 700 is to be paused or stopped, etc. In response to a determination that process 700 is complete, process 700 ends. In response to a determination that process 700 is not complete, process 700 returns to 705.

FIG. 8 is a flow diagram of a method for handling DNS traffic according to various embodiments. According to various embodiments, process 800 is implemented at least in part by one or more of system 100 of FIG. 1, system 300 of FIG. 3, and/or system 400 of FIG. 4.

In some implementations, process 800 may be implemented by one or more servers, such as in connection with providing a service to a network (e.g., a security entity and/or a network endpoint such as a client device). In some implementations, process 800 may be implemented by a security entity (e.g., a firewall) such as in connection with enforcing a security policy with respect to files communicated across a network or in/out of the network. In some implementations, process 800 may be implemented by a client device such as a laptop, a smartphone, a personal computer, etc., such as in connection with communicating DNS traffic across a network.

At 805, the system obtains a DNS traffic sample. At 810, the system performs a lookup to determine whether a DNS cache stores information for the DNS traffic sample. At 815, the system determines whether the DNS cache stores DNS information for the DNS traffic sample. In response to determining that the DNS cache stores the DNS information, process 800 proceeds to 850. Conversely, in response to determining that the DNS information is not stored in the DNS cache at 815, process 800 proceeds to 820.

At 820, the system performs a pre-filtering with respect to the DNS traffic sample. As an example, the system can pre-filter the network traffic samples to obtain either a benign DNS traffic sample (e.g., a DNS traffic not deemed to be a candidate for DNS tunneling classification) and a candidate for DNS tunneling classification. At 825, the system determines whether a classification is to be obtained. In some embodiments, the system determines whether to obtain a DNS tunneling classification based on the output/results from the prefiltering.

In response to determining that a classification is not to be obtained, process 800 proceeds to 830 at which the system obtains DNS information from and aDNS service. For example, the system queries an aDNS service for the DNS information (e.g., a DNS record). Thereafter, process 800 proceeds to 850 at which the system provides a response for the DNS traffic sample. For example, the system obtains a DNS record from a local cache (e.g., a cache of previously obtained DNS records for domains) or obtains the DNS record from the aDNS service, and the system provides the DNS record (e.g., to the client system/endpoint from which the DNS record originated, to the service that invoked process 800, etc.).

In response to determining that a classification (e.g., DNS tunneling classification) is to be performed, process 800 proceeds to 835 at which the system obtains a classification for the candidate DNS traffic sample. In some embodiments, the system obtains a DNS tunneling classification by querying a classifier (e.g., a machine learning model trained to detect DNS tunneling). At 840, the system determines whether the DNS traffic sample corresponds to DNS tunneling. For example, the system determines whether the DNS tunneling classification indicates that the DNS traffic sample is predicted to be DNS tunneling (e.g., a likelihood that the DNS traffic sample is DNS tunneling exceeds a predefined threshold).

In response to determining that the DNS traffic sample corresponds to DNS tunneling, process 800 proceeds to 830. Conversely, in response to determining that the DNS traffic sample does not correspond to DNS tunneling, process 800 proceeds to 845. At 845, the system causes the DNS traffic sample to be handled according to the classification (e.g., that the DNS traffic sample is DNS tunneling). In some embodiments, the system causes the DNS traffic sample to be handled according to the classification by causing a security policy to be applied with respect to the DNS traffic sample. For example, in the case that the system is a remote service (e.g., a cloud service), the system can provide an indication to a security entity (e.g., a next generation firewall) that the DNS traffic sample is a DNS tunneling (e.g., associated with a DNS tunneling attack/campaign). As another example, in the case that the system is a remote service (e.g., a cloud service), the system can provide an indication of a particular policy (e.g., a security policy) to be applied/enforced, or can provide an indication of an active measure to be performed based on a security policy. In the case that the system is a security entity, such as an inline security entity (e.g., a next generation firewall), the system causes the DNS traffic sample to be handled according to the classification by determining a security policy to be applied (e.g., a security policy mapped to a DNS tunneling attack/classification) and enforcing the security policy.

At 855, the system determines whether process 800 is complete. In some embodiments, process 800 is determined to be complete in response to a determination that no further samples (e.g., DNS queries) are to be analyzed (e.g., no further predictions for traffic are needed), no further DNS traffic is to be classified, no further network traffic is received/intercepted, an administrator indicates that process 800 is to be paused or stopped, etc. In response to a determination that process 800 is complete, process 800 ends. In response to a determination that process 800 is not complete, process 800 returns to 805.

FIG. 9 is a flow diagram of a method for prefiltering DNS traffic according to various embodiments. According to various embodiments, process 1200 is implemented at least in part by one or more of system 100 of FIG. 1, system 300 of FIG. 3, and/or system 400 of FIG. 4.

In some implementations, process 900 may be implemented by one or more servers, such as in connection with providing a service to a network (e.g., a security entity and/or a network endpoint such as a client device). In some implementations, process 900 may be implemented by a security entity (e.g., a firewall) such as in connection with enforcing a security policy with respect to files communicated across a network or in/out of the network. In some implementations, process 900 may be implemented by a client device such as a laptop, a smartphone, a personal computer, etc., such as in connection with communicating DNS traffic across a network.

In some embodiments, process 900 is invoked by process 600 (e.g., at 610), process 700 (e.g., 710) and/or process 800 (e.g., 820).

In some embodiments, the system implements a pre-filtering stage to rapidly discard DNS queries that the system deems to clearly (or very likely) not pose tunneling risks, thereby reducing the load on more advanced classification processes. By efficiently screening out DNS queries associated with recognized benign or invalid domains, the system concentrates its time and computational resources on only those DNS queries that exhibit potentially suspicious characteristics. This streamlined approach not only speeds up overall analysis but also reduces the chance of false alarms by separating the unambiguously safe traffic from those queries requiring deeper scrutiny.

According to various embodiments, during pre-filtering, the system checks for a variety of conditions that can quickly confirm whether a given domain is unlikely to be used for tunneling. One such condition is whether the queried top-level domain is known to be reserved for exclusive use by a legitimate organization. The system also looks for domains lacking valid registrations, such as those with non-existent TLDs, as well as domains that are so obviously malformed or incomplete that they cannot realistically be queried on the public internet. In addition, queries for domains contained in a continuously maintained list of known benign or highly popular domains are identified and bypassed (e.g., filtered out from the resulting set of DNS tunneling classification candidates). Domains with widely recognized reputations or strong hosting profiles are deemed to present negligible risk for tunneling, so the system deems them as safe without further processing. If a query is for an empty domain (such as a request to resolve “.com” by itself) or a popular subdomain that contains no unusual encoding, the system similarly treats it as benign and bypasses higher-level inspection.

In order to make these determinations, the system relies on a local cache, or database populated with both public and proprietary data sources, or querying third-party services. For example, the system can use official TLD zone files, third-party reputation services, and logs of high-volume benign domains maintained by major security vendors or open-source communities. By regularly querying or syncing with these external data feeds, the system stays informed about newly created domains, changes in domain ownership or hosting infrastructure, and updates to lists of known malicious or benign services. Through these updates, the system ensures that the pre-filtering checks remain accurate and reflective of the current landscape. In practice, the pre-filtering component might query a fast in-memory data store, such as Redis, to determine if a domain or its authoritative nameservers appear on a trusted list, show invalid registration records, or match a known benign service. The resulting categorization is then applied in real time (e.g., instantly), allowing safe network traffic (e.g., DNS traffic) to pass quickly and ensuring that suspicious or novel queries progress to deeper analysis.

Returning to the example shown, at 905, the system obtains an indication to pre-filter a DNS query. For example, in response to the DNS query being intercepted by a security entity (e.g., an inline firewall such as a next generation firewall).

At 910, the system determines whether the DNS traffic sample (e.g., the DNS query) is associated with (e.g., for/directed to) a trusted top-level domain. In response to determining that the DNS traffic sample is associated with a top-level domain proceeds to 940. For example, in response to determining that the DNS traffic sample is associated with a trusted top-level domain, the system determines that the DNS traffic sample (e.g., a DNS query) is not a candidate for DNS traffic classification (e.g., a DNS record may be obtained and provided in response to the DNS query). Conversely, in response to determining that the DNS traffic sample is not associated with a trusted top-level domain, process 900 proceeds to 915.

At 915, the system determines whether the DNS traffic sample (e.g., the DNS query) is associated with (e.g., for/directed to) an invalid top-level domain. For example, the system determines whether the TLD for the DNS query has a TLD for an internal network end process (e.g., .local, .internal, etc.). In response to determining that the DNS traffic sample is associated with an invalid top-level domain, process 900 proceeds to 940. For example, in response to determining that the DNS traffic sample is associated with an invalid top-level domain, the system determines that the DNS traffic sample (e.g., a DNS query) is not a candidate for DNS traffic classification (e.g., a DNS record may be obtained and provided in response to the DNS query). Conversely, in response to determining that the DNS traffic sample is not associated with an invalid top-level domain, process 900 proceeds to 920.

At 915, the system determines whether the DNS traffic sample (e.g., the DNS query) comprises empty data. In response to determining that the DNS traffic sample comprises empty data, process 900 proceeds to 940. For example, in response to determining that the DNS traffic comprises empty data, the system determines that the DNS traffic sample (e.g., a DNS query) is not a candidate for DNS traffic classification (e.g., a DNS record may be obtained and provided in response to the DNS query). Conversely, in response to determining that the DNS traffic sample is not associated with an invalid top-level domain, process 900 proceeds to 925.

At 925, the system determines whether the DNS traffic sample (e.g., the DNS query) is associated with (e.g., for/directed to) a known benign domain. For example, the system determines whether the domain for the DNS query is for/directed to a domain that has been previously classified as benign or a domain comprised on an allowlist, etc. In response to determining that the DNS traffic sample is for a known benign domain, process 900 proceeds to 940. For example, in response to determining that the DNS traffic sample is associated with a benign domain, the system determines that the DNS traffic sample (e.g., a DNS query) is not a candidate for DNS traffic classification (e.g., a DNS record may be obtained and provided in response to the DNS query). Conversely, in response to determining that the DNS traffic sample is not associated with a known benign domain, process 900 proceeds to 930.

At 930, the system determines whether the DNS traffic sample (e.g., the DNS query) is associated with (e.g., for/directed to) a popular subdomain. For example, the system determines whether the subdomain for the DNS query is for/directed to a domain that is on a predefined list, such as a list of popular subdomains. The list of popular subdomains may be obtained based at least in part on a third-party service (e.g., the third-party service may maintain/provide a list of popular subdomains. Additionally, or alternatively, the list of popular subdomains may be obtained based at least in part on empirical evidence (e.g., observations across one or more networks). In response to determining that the DNS traffic sample is for a popular subdomain, process 900 proceeds to 940. For example, in response to determining that the DNS traffic sample is associated with a popular subdomain, the system determines that the DNS traffic sample (e.g., a DNS query) is not a candidate for DNS traffic classification (e.g., a DNS record may be obtained and provided in response to the DNS query). Conversely, in response to determining that the DNS traffic sample is not associated with a popular subdomain, process 900 proceeds to 935.

At 935, the system provides an indication that the DNS traffic sample is a candidate for DNS tunneling classification. In some embodiments, the system provides the indication that the DNS traffic sample is a candidate for DNS tunneling classification to another system, service, or process that invoked process 900.

At 940, the system provides an indication that the DNS traffic sample is not DNS tunneling. In some embodiments, the system provides the indication that the DNS traffic sample does not correspond to a DNS tunneling attack/campaign to another system, service, or process that invoked process 900.

At 945, the system determines whether process 900 is complete. In some embodiments, process 900 is determined to be complete in response to a determination that no further samples (e.g., DNS queries) are to be analyzed (e.g., no further predictions for traffic are needed), no further DNS traffic is to be classified, no further network traffic is received/intercepted, an administrator indicates that process 900 is to be paused or stopped, etc. In response to a determination that process 900 is complete, process 900 ends. In response to a determination that process 900 is not complete, process 900 returns to 905.

FIG. 10 is a flow diagram of a method for performing a DNS tunnelling classification according to various embodiments. According to various embodiments, process 1200 is implemented at least in part by one or more of system 100 of FIG. 1, system 300 of FIG. 3, and/or system 400 of FIG. 4.

In some implementations, process 1000 may be implemented by one or more servers, such as in connection with providing a service to a network (e.g., a security entity and/or a network endpoint such as a client device). In some implementations, process 1000 may be implemented by a security entity (e.g., a firewall) such as in connection with enforcing a security policy with respect to files communicated across a network or in/out of the network. In some implementations, process 1000 may be implemented by a client device such as a laptop, a smartphone, a personal computer, etc., such as in connection with communicating DNS traffic across a network.

In some embodiments, the system begins by extracting a variety of features for each DNS query or response and then feeding these features into a classification algorithm. One core set of features pertains to characteristics of the queried domain's authoritative nameserver. Tunneling domains are often served by privately controlled nameservers, rather than by large, reputable DNS hosting providers. Therefore, the system checks whether the authoritative nameserver is dedicated to a single domain, whether it appears on public blacklists or whitelists, and/or whether its domain has a history of malicious behavior. Through these checks, the system uncovers signs of adversary ownership or recent registrations that are at odds with typical legitimate domains.

Another set of features that the system may extract pertain to the domain names themselves. If the subdomain portion of a DNS query contains suspicious strings or encodings, such as unusually long random sequences or invalid characters that do not align with typical naming conventions, the system may treat that domain as high risk (e.g., the system may correspondingly set the feature value). In contrast, legitimate subdomains often comprise recognizable words or meaningful identifiers rather than unstructured text. The system further examines whether the domain name is known to be associated with a reputable organization, or whether it has a track record of benign activity.

The system can combine features computed based on a plurality of signals to form an overall profile that the system can use to detect whether DNS traffic sample (e.g., a DNS query or a DNS response) is likely an attempt to exfiltrate or infiltrate data.

After features are computed, the system queries a trained classifier to produce an anomaly or risk score. For instance, a random forest model might be used, built upon decision trees that each evaluate the DNS query's features in stages. In a hypothetical scenario, when the system encounters a DNS request for “abc123.some-dns-example[.]com,” it starts by reviewing the extracted features: whether “some-dns-example[.]com” uses a suspiciously dedicated nameserver, how many meaningful words appear in “abc123,” the reputation of the domain, and whether any unusual characters or encodings are observed. These feature values then pass into each decision tree, which segregates them based on defined threshold conditions. In a high-level sense, if enough trees agree that “abc123.some-dns-example[.]com” matches patterns consistent with tunneling, the random forest returns a higher probability that the DNS query is malicious (e.g., a higher likelihood that the DNS query corresponds to DNS tunneling activity).

Once the classification decision is made, the system can promptly perform an active measure, such as to immediately blocking or flagging the DNS query if the model identifies it as malicious. In some embodiments, the system implements this process/technique rapidly enough to intercept the resolution in real time, ensuring that no data is exfiltrated through DNS tunneling. If the model deems the DNS query benign, the resolver or security entity proceeds with a normal DNS lookup. Over time, the model can be updated or retrained with new examples to capture emerging tunneling patterns, maintaining an adaptive and scalable solution for enterprise protection.

At 1005, the system obtains an indication that a classification is to be obtained for a DNS traffic sample. At 1010, the system extracts one or more features for the DNS traffic sample. At 1015, the system queries a classifier for a DNS tunneling classification. At 1020, the system provides the classification for the DNS traffic sample. At 1025, the system determines whether process 1000 is complete. In some embodiments, process 1000 is determined to be complete in response to a determination that no further samples are to be analyzed (e.g., no further predictions for traffic are needed), no further correlated traffic is to be classified, no further network traffic is received, an administrator indicates that process 1000 is to be paused or stopped, etc. In response to a determination that process 1000 is complete, process 1000 ends. In response to a determination that process 1000 is not complete, process 1000 returns to 1005.

FIG. 11 is a flow diagram of a method for deploying a model for performing DNS tunneling classification according to various embodiments. According to various embodiments, process 1100 is implemented at least in part by one or more of system 100 of FIG. 1, system 300 of FIG. 3, and/or system 400 of FIG. 4.

The system prepares its classification model by assembling a large dataset of labeled DNS traffic, which includes both confirmed tunneling queries and known benign queries. This data may be gathered from sources such as enterprise networks, security research, and simulated tunneling scenarios. Before training begins, each DNS query and associated DNS information undergoes feature extraction to transform raw protocol information into a structured form suitable for machine learning. These features may reflect attributes of the domain name itself, characteristics of the authoritative nameserver, and any indicators of malicious or benign reputation. By labeling the data with ground truth (e.g., whether the traffic is legitimate or part of a tunneling scheme), the system provides the model with examples of what to identify as dangerous (e.g., likely to be associated with a DNS tunneling attack/campaign) and what to classify as benign.

Once the labeled dataset is prepared, the system trains a supervised machine learning algorithm, such as a random forest, on the feature vectors and their associated labels. In the case of a machine learning model implementing the random forest technique, during this training process, the random forest constructs multiple decision trees that independently learn patterns in the data. Each tree relies on a subset of the features and training examples, increasing the overall robustness of the model. As the random forest refines itself, it attempts to reduce the classification errors by adjusting how the decision trees split the dataset. This iterative procedure continues until the forest converges on a set of decision boundaries that offer high accuracy for the tunneling detection problem. After training is complete, the model is validated against a separate dataset to confirm that it generalizes well to new, unseen DNS queries.

When the model is ready for production use, it may be deployed in a variety of environments depending on the needs of the organization. One popular arrangement is to host the trained model within a cloud service specifically designed for real-time security scanning. In this setup, network security appliances (e.g., security entities) such as next-generation firewalls forward DNS traffic or feature vectors to the cloud (e.g., for classification and/or resolving), where the model performs the classification. The cloud service can scale to handle vast numbers of DNS queries with minimal latency, making it well-suited to protect large enterprises or service providers handling global DNS traffic. The implementation at a cloud service also allows the security vendor to apply updates or retrain the model centrally, ensuring that all connected security entities (e.g., firewalls and gateways) benefit from the latest detection capabilities.

Alternatively, or additionally, the system can operate on premises by integrating the model into localized security appliances or DNS resolvers. This implementation keeps sensitive traffic data within the customer's own network, which may be preferred for compliance or privacy reasons. As an example, depending on the hardware resources available, the model can either run in a lightweight inference engine directly on the firewall or rely on a more powerful local server for resource-intensive analysis. Regardless of the chosen deployment model, the fundamental process remains the same: DNS traffic flows through a classification pipeline where the machine learning model uses the extracted features to quickly determine whether a query is benign or suggests tunneling activity.

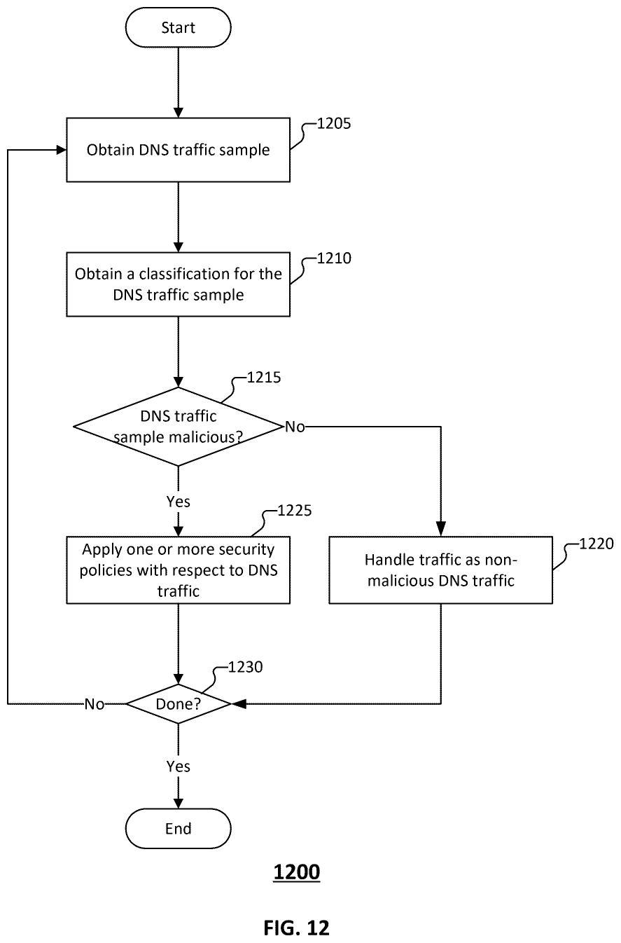

Returning to the example shown, at 1105, information pertaining to a set of historical malicious DNS tunneling traffic samples is obtained. For example, the set of historical malicious samples include samples of malicious DNS traffic samples for DNS traffic that has been previously classified (or identified) as corresponding to malicious traffic (e.g., as corresponding to a DNS tunneling attack/campaign). In some embodiments, the system obtains the information pertaining to a set of historical malicious DNS traffic samples from a third-party service (e.g., VirusTotal™). At 1110, information pertaining to a set of historical benign/non-malicious DNS traffic samples is obtained. For example, the set of historical benign DNS traffic samples include samples of DNS queries or DNS responses that are to known benign domains, trusted top-level domains, or on a predefined mapping of non-malicious domains (e.g., based on previous DNS tunneling classifications, etc.). In some embodiments, the system obtains the information pertaining to a set of historical benign DNS traffic samples from a third-party service (e.g., VirusTotal™). At 1115, the system determines one or more relationships between characteristic(s) of samples of network traffic sessions and indications that the samples are malicious samples. At 1120, a model is trained for determining whether a DNS traffic profile for DNS traffic time series data associated with DNS traffic is malicious. Examples of machine learning processes that can be implemented in connection with training the model include random forest, linear regression, support vector machine, naive Bayes, logistic regression, K-nearest neighbors, decision trees, gradient boosted decision trees, K-means clustering, hierarchical clustering, density-based spatial clustering of applications with noise (DBSCAN) clustering, principal component analysis, XGBoost, etc. At 1125, the model is deployed. In some embodiments, the deploying of the model includes storing the model in a dataset of models for use in connection with analyzing traffic to determine whether the traffic is malicious. The deploying the model can include providing the model (or a location at which the model can be invoked) to a malicious traffic detector, such as DNS security service 170 of system 100 of FIG. 1, or to system 300 of FIG. 3, and/or system 400 of FIG. 43. At 1130, the system determines whether process 1100 is complete. In some embodiments, process 1100 is determined to be complete in response to a determination that no further models are to be determined/trained (e.g., no further classification models are to be created), an administrator indicates that process 1100 is to be paused or stopped, etc. In response to a determination that process 1100 is complete, process 1100 ends. In response to a determination that process 1100 is not complete, process 1100 returns to 1105.

At 1230, the system determines whether process 1200 is complete. In some embodiments, process 1200 is determined to be complete in response to a determination that no further samples are to be analyzed (e.g., no further predictions for traffic are needed), no further correlated traffic is to be classified, no further network traffic is received, an administrator indicates that process 1200 is to be paused or stopped, etc. In response to a determination that process 1200 is complete, process 1200 ends. In response to a determination that process 1200 is not complete, process 1200 returns to 1205.

FIG. 12 is a flow diagram of a method for handling DNS traffic based on DNS traffic classifications according to various embodiments. According to various embodiments, process 1200 is implemented at least in part by one or more of system 100 of FIG. 1, system 300 of FIG. 3, and/or system 400 of FIG. 4.

In some implementations, process 1200 may be implemented by one or more servers, such as in connection with providing a service to a network (e.g., a security entity and/or a network endpoint such as a client device). In some implementations, process 1200 may be implemented by a security entity (e.g., a firewall) such as in connection with enforcing a security policy with respect to files communicated across a network or in/out of the network. In some implementations, process 1200 may be implemented by a client device such as a laptop, a smartphone, a personal computer, etc., such as in connection with communicating DNS traffic across a network.

In some embodiments, the system comprises a cloud service that provides near real-time traffic detection (e.g., a detection latency from the cloud service may be on the order of 10-50 ms).

According to various embodiments, the DNS tunneling classification generated by the system is a focal point for applying security policies that control whether DNS traffic is allowed to proceed. By integrating with inline security devices (e.g., security entities) such as firewalls or secure web gateways, the system can ensure that its verdicts on potential DNS tunneling are enforced in real time in the flow of network traffic. This integration can be accomplished through a direct API, a shared cache of threat indicators, or specialized protocols that synchronize classification results across multiple security appliances. Once a DNS query or response is flagged as malicious, the security device implementing the policy can perform the active measure in real time (e.g., drop the DNS query upon DNS tunneling detection), preventing any sensitive data from being exfiltrated or malicious instructions from infiltrating the network.

In more advanced configurations, the system can communicate a more nuanced policy decision that goes beyond merely blocking a single query. For instance, if a particular domain or nameserver is consistently associated with high-risk behavior, the system may instruct the firewall or gateway to isolate all traffic associated with that domain until further notice. Administrators can then investigate the situation by analyzing logs, reviewing network behavior, and possibly running deeper forensic checks. This form of quarantine allows the organization to minimize disruption to legitimate services while ensuring that any potential threat is contained swiftly. Should further analysis reveal that the domain or nameserver is truly malicious (e.g., corresponds to a DNS tunneling attack or campaign), the security device can continue to enforce a long-term block. If the DNS tunneling classification turns out to be a false positive, the system can rapidly update its verdict and restore full connectivity.

In addition to, or as an alternative to, blocking or quarantining, the system may direct suspicious DNS queries and responses to a sinkhole. This approach involves substituting the original destination with a controlled IP address or server managed by the security team. By responding with non-threatening or deceptive data, the organization can observe how compromised hosts or adversaries react, gaining valuable intelligence about the nature and intentions behind the tunneling attempt. Meanwhile, the sinkholed traffic poses no risk to the network, as it never reaches the true malicious endpoint. By implementing a sinkholing option, the system provides an additional layer of strategic defense that can yield crucial insights into attacker tactics while still safeguarding business operations.

Whenever a particular policy decision is made (e.g., whether block, quarantine, or sinkhole DNS traffic), the system can log the corresponding event and optionally forwards it to a centralized management console or security information and event management (SIEM) platform. This helps create a cohesive overview of DNS-based threats across the organization, enabling rapid correlation with other security events. Network security administrators may benefit from real-time alerts and detailed logs, which offer both immediate protection and a historical record for post-incident analysis. Through this combination of quick decisions, flexible enforcement options, and comprehensive logging, the system ensures that malicious DNS tunneling activities are contained and investigated without unnecessarily negatively impacting normal network traffic.

Returning to the example shown, 1205, the system obtains a DNS traffic sample(s). The system may obtain network traffic sample(s) such as in connection with routing traffic within/across a network, or mediating traffic into/out of a network such as a firewall, etc.

At 1210, the system obtains a classification (e.g., a DNS tunneling classification) for the DNS traffic sample. For example, the system determines whether the DNS traffic sample is malicious. In some embodiments, the system queries a classifier for a contemporaneous DNS traffic classification (e.g., a real-time detection). For example, the system determines a DNS traffic profile and queries a classifier for a predicted classification based on the DNS traffic profile. In some embodiments, the system queries a whitelist (e.g., an allowlist) or a blacklist (e.g., a denylist) to determine whether the DNS traffic sample corresponds to an entry. For example, the system can query the whitelist or blacklist based on the domain associated with the DNS traffic sample or a DNS record comprised in the DNS traffic sample. The system may determine a signature for the DNS traffic sample (e.g., the domain and/or the DNS record) and query the whitelist and/or blacklist based on the signature.

In some embodiments, process 1200 invokes process 1000 of FIG. 10 in connection with obtaining the classification.

According to various embodiments the system obtains a classification for the DNS traffic sample based at least in part on performing a look up against a blacklist (e.g., a denylist or a mapping of malicious samples to signatures) and/or whitelist (e.g., an allow list or a mapping of non-malicious or benign samples to signatures). The system can determine whether the DNS traffic sample (e.g., the correlated network traffic) has been previously analyzed/classified. For example, in response to performing a classification (e.g., a DNS tunneling classification), the system computes a signature (e.g., perform a hash based on a predefined hashing function) and stores the signature in association with the classification.

In some embodiments, the system determines whether the DNS traffic sample corresponds to a sample comprised in a set of previously identified benign samples such as a whitelist of benign samples. In response to determining that the DNS traffic sample is comprised in the set of samples on the whitelist of benign samples, the system determines that the DNS traffic sample is not malicious.

According to various embodiments, in response to determining the DNS traffic sample is not comprised in a set of previously identified malicious samples (e.g., a blacklist of malicious samples) or a set of previously identified benign samples (e.g., a whitelist of benign files), the system deems the traffic DNS traffic as being non-malicious (e.g., benign) for the first-layer classification or the second-layer classification, as applicable.

According to various embodiments, in response to determining the DNS traffic sample is not comprised in a set of previously identified malicious samples (e.g., a blacklist of malicious samples) or a set of previously identified benign samples (e.g., a whitelist of benign samples), the system queries a malicious DNS traffic detector to determine whether the DNS traffic is malicious (e.g., to perform automatic DNS traffic detection). For example, the system may quarantine the DNS traffic until the system receives response form the malicious DNS traffic detector as to whether the DNS traffic sample is malicious. The malicious traffic detector may perform an assessment of whether the DNS traffic sample is malicious contemporaneous with the handling of the DNS traffic by the system (e.g., in real-time with the query from the system). The malicious traffic detector may correspond to DNS security service 170 of system 100 of FIG. 1, system 300 of FIG. 3, and/or system 400 of FIG. 4.

In some embodiments, in response to determining that the DNS traffic sample has not been previously classified, process 1200 can invoke process 700 of FIG. 7 and/or process 1000 of FIG. 10.

At 1215, the system determines whether the network traffic sample is malicious (e.g., corresponds to DNS tunneling). For example, the system determines whether the classification indicates that the sample is malicious. As another example, the system determines whether the classification (e.g., the verdict from the second-layer classifier) comprises a probability or likelihood that the sample is malicious that exceeds a predefined maliciousness threshold.

In response to a determination that the traffic is not malicious traffic at 1215, process 1200 proceeds to 1220 at which the traffic is handled as non-malicious traffic/information.

In response to a determination that the traffic sample is malicious at 1215, process 1200 proceeds to 1225 at which the traffic is handled as malicious traffic/information. The system may handle the malicious traffic/information based at least in part on one or more policies such as one or more security policies.

According to various embodiments, the handling of malicious traffic/information may include performing an active measure. The active measure may be performed in accordance with (e.g., based at least in part on) one or more security policies. As an example, the one or more security policies may be preset by a network administrator, a customer (e.g., an organization/company) to a service that provides detection of malicious traffic, etc. Examples of active measures that may be performed include isolating the traffic (e.g., quarantining the traffic, for example, sinkholing the DNS query), deleting the traffic, blocking the traffic (e.g., blocking the return of a corresponding DNS record), prompting the user to alert the user that a malicious traffic was detected, blocking transmission of the traffic, updating a blacklist of malicious samples (e.g., a mapping of a hash for the traffic sample to an indication that the traffic sample is malicious, etc.).

At 1230, the system determines whether process 1200 is complete. In some embodiments, process 1200 is determined to be complete in response to a determination that no further samples are to be analyzed (e.g., no further predictions for traffic are needed), no further correlated traffic is to be classified, no further network traffic is received, an administrator indicates that process 1200 is to be paused or stopped, etc. In response to a determination that process 1200 is complete, process 1200 ends. In response to a determination that process 1200 is not complete, process 1200 returns to 1205.

Various examples of embodiments described herein are described in connection with flow diagrams. Although the examples may include certain steps performed in a particular order, according to various embodiments, various steps may be performed in various orders and/or various steps may be combined into a single step or in parallel.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
one or more processors configured to:
obtain a single DNS query;
determine if the single DNS query is associated with DNS tunneling (DNST) using a classifier; and
perform active measure in response to determining that the single DNS query is associated with the DNST; and
a memory coupled to the one or more processors and configured to provide the one or more processors with instructions.

2. The system of claim 1, wherein the single DNS query is obtained based on monitoring network traffic.

3. The system of claim 1, wherein the single DNS query is intercepted by a security entity from DNS traffic across a network.

4. The system of claim 3, wherein the obtaining the single DNS query comprises receiving, at a security service, the single DNS query from the security entity.

5. The system of claim 1, wherein the classifier is a machine learning model.

6. The system of claim 5, wherein the machine learning model is an isolation forest machine learning model.

7. The system of claim 1, wherein performing the active measure comprises one or more of (a) blocking the single DNS query, (b) dropping the single DNS query, (c) logging the single DNS query, and (d) quarantining the single DNS query.

8. The system of claim 1, wherein the active measure is determined based at least in part on a predefined security policy.

9. The system of claim 1, wherein determining if the single DNS query is associated with DNST using the classifier comprises:
querying the classifier for a predicted DNS traffic classification; and
obtaining the predicted DNS traffic classification from the classifier.

10. The system of claim 9, wherein determining if the single DNS query is associated with DNST using the classifier further comprises:
extracting a set of features.

11. The system of claim 10, wherein at least a subset of the set of features is based at least in part on one or more characteristics of an authoritative nameserver (aDNS) associated with the single DNS query.

12. The system of claim 11, wherein the one or more characteristics of the aDNS comprise a reputation of the aDNS.

13. The system of claim 11, wherein the one or more characteristics of the aDNS comprise a popularity of the aDNS.

14. The system of claim 10, wherein the set of features comprises a feature based at least in part on one or more characteristics of a domain registration for a queried domain associated with the single DNS query.

15. The system of claim 10, wherein the set of features comprises a feature based at least in part on a ratio of meaningful words to total words for words in a hostname part of a fully qualified domain name (FQDN) associated with the DNS query.

16. The system of claim 10, wherein the set of features comprises a feature based at least in part on one or more characteristics of traffic from one or more applications or services known to be benign.

17. The system of claim 1, wherein determining if the single DNS query is associated with DNST using the classifier comprises:
prefiltering as non-DNS tunneling traffic the single DNS query in response to determining that the DNS query is associated with a queried domain having top level domains (TLD) that is not available for public registration.

18. The system of claim 1, wherein the single DNS query is a first DNS query in a DNS tunneling attack.

19. A method, comprising:
obtaining a single DNS query;
determining if the single DNS query is associated with DNS tunneling (DNST) using a classifier; and
performing active measure in response to determining that the single DNS query is associated with the DNST.

20. A computer program product embodied in a non-transitory computer readable medium and comprising computer instructions for:
obtaining a single DNS query;
determining if the single DNS query is associated with DNS tunneling (DNST) using a classifier; and
performing active measure in response to determining that the single DNS query is associated with the DNST.

21. A method for training a machine learning-based classifier for inline DNS tunnelling traffic based on a single DNS query, comprising:
obtaining a set of training sample DNS queries;
obtaining DNS traffic information for the set of training sample domains;
performing a machine learning process to generate a DNS traffic classifier; and
deploying the DNS traffic classifier in a system to perform near real-time detection of DNS tunneling traffic.

22. The method of claim 21, wherein the DNS traffic classifier classifies a DNS traffic sample based on a single DNS query.
